(19) United States
(12) Patent Application Publication
(10) Pub. No.: US 2026/0259978 A1
(43) Pub. Date: Sep. 3, 2026

(54) Permissive DPU Hardware Processing

(71) Applicant: CrowdStrike, Inc., Sunnyvale, CA (US)

(72) Inventor: Andrew Southgate, Cambridge (GB)

(73) Assignee: CrowdStrike, Inc., Sunnyvale, CA (US)

(21) Appl. No.: 19/067,855

(22) Filed: Mar. 1, 2025

(51) Int. Cl. G06F 21/54; G06F 21/53; G06F 21/55

(52) U.S. Cl. CPC G06F 21/54; G06F 21/53; G06F 21/554

(57) ABSTRACT

A permissive computing resource service detects unauthorized hardware processing assigned to an auxiliary data processing unit (DPU). The DPU is commonly a graphics processing unit (GPU), but unauthorized hardware processing may be detected in other hardware accelerators. When tasks are assigned to the DPU/GPU, responsible parties are notified of the tasks assigned to the DPU/GPU. The responsible parties may thus respond with hardware processing authorizations that authorize the DPU/GPU to execute the tasks. If, however, one or more of the responsible parties fails to reply, or denies, then the DPU/GPU is not authorized to execute the tasks. The tasks, for example, may represent impermissible usage of the DPU/GPU or unsafe/abnormal behavior. The tasks may thus represent DPU hardware processing theft.

### BACKGROUND

The subject matter described herein generally relates to computers and to communications and, more particularly, the subject matter relates to computer and network security.

Cybersecurity threats are always increasing. It seems every day there is another cybersecurity attack that steals account passwords, business data, and personal information. Emails, websites, and text messages often contain malicious links, viruses, and attachments. Now, even artificial intelligence and machine learning are targeted by cyberattackers.

### SUMMARY

A permissive computing resource service detects unauthorized hardware processing assigned to an auxiliary data processing unit (or DPU). The DPU is commonly a graphics processing unit (or GPU), but unauthorized hardware processing may be detected in other hardware accelerators. The DPU/GPU allows a computer system to execute additional workloads (such as artificial intelligence, machine learning, and other high performance computing tasks). The computer system may thus hand off or assign processing tasks to the DPU/GPU for dramatically faster execution of additional workloads.

The permissive computing resource service, though, monitors the tasks assigned to the DPU/GPU. Today's high-performance DPU/GPU designs are capable of processing many terabytes of data. Today's high-performance DPU/GPU designs thus allow researchers to employ giant-scale artificial intelligence (AI) and machine learning (ML) to discover solutions for the most complex of problems. As researchers are also discovering, though, AI/ML may cause problems and perhaps even harm. So, when tasks are assigned to the DPU/GPU, the permissive computing resource service notifies responsible parties of the tasks assigned to the DPU/GPU. The DPU/GPU holds or suspends processing while the responsible parties evaluate the tasks. The DPU/GPU, as examples, may send messages to a user, a manufacturer, or even a governmental entity. Indeed, there may be many responsible parties who wish to be notified of the tasks assigned to the DPU/GPU. Each message describes the tasks and requests that each responsible party/entity/server approve or deny the tasks. Each responsible party, for example, may have its own governing policies that define or specify permissible and impermissible uses of the DPU/GPU. If the responsible parties affirmatively respond, then the DPU/GPU may proceed and execute the tasks. If, however, one or more of the responsible parties denies the tasks, then the DPU/GPU is not authorized to execute the tasks. The tasks, for example, may represent impermissible usage of the DPU/GPU. The tasks may match or resemble unsafe/abnormal patterns of behavior. The tasks may even represent a cybersecurity threat. Whatever the reason(s), the tasks may be deemed DPU hardware processing theft.

### BRIEF DESCRIPTION OF THE SEVERAL VIEWS OF THE DRAWINGS

The features, aspects, and advantages of permissive DPU hardware processing are understood when the following Detailed Description is read with reference to the accompanying drawings, wherein:

FIGS. 1-3 illustrate some examples of detecting hardware processing theft;

FIGS. 4-7 illustrate more examples of processing oversight;

FIG. 8 illustrates examples of continued processing oversight;

FIGS. 9-10 illustrate examples of timed DPU hardware usage;

FIG. 11 illustrates examples of multiple permissions parties;

FIGS. 12, 13A-B, & 14 illustrate examples of endpoint processing protective trusted execution environments (or TEEs);

FIGS. 15-16 illustrate examples of queueing schemes;

FIG. 17 illustrates examples of agent monitoring;

FIG. 18 illustrates examples of local assessment; and

FIGS. 19-21 illustrate examples of methods or operations that monitor DPU hardware usage.

### DETAILED DESCRIPTION

Some examples relate to detecting and predicting abnormal or even malicious work performed by an auxiliary data processing unit (or DPU). The DPU is commonly a graphics processing unit (or GPU) that is installed in a computer system. The DPU/GPU provides a significant performance boost to the computer system. Even smartphones and laptops use the DPU/GPU to generate faster results. In fact, it's the high-performance DPU/GPU designs that have ushered in the promises of artificial intelligence (AI) and machine learning (ML). Large clusters of computers, using AI/ML and many DPUs/GPUs, have discovered new drugs, screened diseases, and found solutions to complex problems.

As we know, though, AI/ML may also cause problems. AI/ML has brought deepfake news, photos, and videos. AI/ML has generated harmful, biased solutions and recommendations. AI/ML has been used to impermissibly obtain personal data and hack accounts. AI/ML has been used to clone voices and faces and to steal identities. AI/ML relies on energy-intensive computations having a significant carbon footprint and that also consume significant amounts of cooling water. AI/ML has also been used to digitally alter people's faces and bodies in very embarrassing and malicious ways.

The permissive computing resource service, though, stops processing before damage is done. The permissive computing resource service monitors the tasks assigned to auxiliary data processing units (or DPUs), graphics processing units (or GPUs), and other hardware accelerators. The permissive computing resource service works very simply and elegantly by requesting prior permission. That is, when the DPU/GPU is requested to perform a task, whatever that task may be, the DPU/GPU first asks for permission. The DPU/GPU reaches out to stakeholders and waits for their permission to proceed. The DPU/GPU, for example, sends a message to DELL®, and the message describes how, why, and where a DELL®-branded computer has assigned the task to the DPU/GPU. The DPU/GPU may then wait for DELL® to respond. If DELL® replies and approves the task, then the DPU/GPU executes the task. If, however, DELL® denies the task, then the DPU/GPU does not execute the task. Simply put, if the DPU/GPU is asked to perform some objectionable or malicious task, the stakeholders may stop the task and prevent harm.

The permissive computing resource service may also stop harmful AI/ML. Let's suppose the DPU/GPU is requested to clone a person's face and voice. The DPU/GPU is given digital photos and recordings in order to clone the person's face and voice. Before cloning, though, the DPU/GPU sends messages describing the cloning task. The DPU/GPU then waits for permission to proceed. IBM®, APPLE®, and MICROSOFT®, as more examples, may wish to be notified whenever their products are involved in the cloning task. Moreover, a local/state/national government may require notification and approval. Indeed, the person being cloned may certainly want notification and approval. The DPU/GPU thus suspends the cloning task to ensure all stakeholders provide their permission to proceed. If the stakeholders approve, perhaps then DPU/GPU executes the cloning task. If, however, the cloning task is determined to be malicious or otherwise harmful, then the DPU/GPU may abandon the cloning task.

Cloning, of course, is only a simple example. In general, the DPU/GPU may seek permission for any computational task. The promises and dangers of artificial intelligence and machine learning, though, highlight the needs for the permissive computing resource service. The permissive computing resource service may cause the DPU/GPU to seek permission before conducting AI/ML modeling, training, prediction, or analysis. The permissive computing resource service thus allows permissible/safe uses of AI/ML, but the permissive computing resource service stops impermissible and harmful uses.

Permissive DPU hardware processing will now be described more fully hereinafter with reference to the accompanying drawings. Permissive DPU hardware processing, however, may be embodied in many different forms and should not be construed as limited to the examples set forth herein. These examples are provided so that this disclosure will be thorough and complete and fully convey permissive DPU hardware processing to those of ordinary skill in the art. Moreover, all the examples of permissive DPU hardware processing are intended to encompass both structural and functional equivalents thereof. Additionally, it is intended that such equivalents include both currently known equivalents as well as equivalents developed in the future (i.e., other elements developed that perform the same function, regardless of structure).

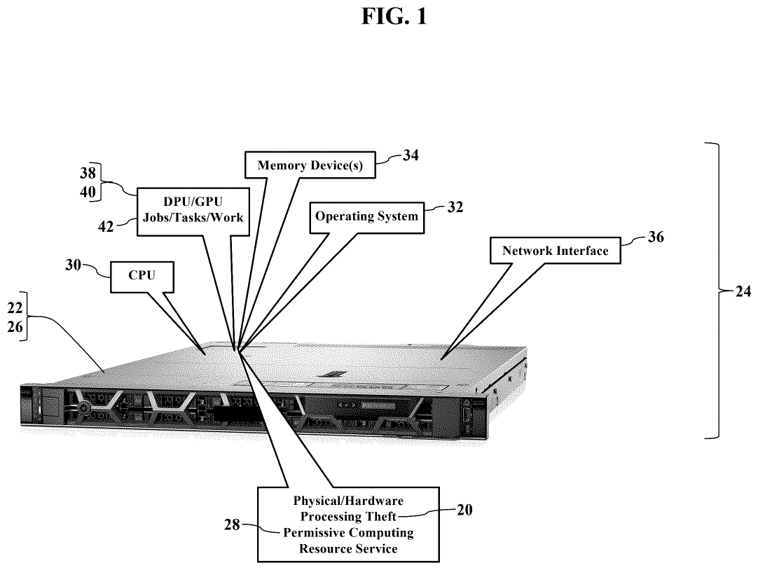

FIGS. 1-3 illustrate some examples of detecting physical and hardware processing theft 20. A computer system 22 monitors its computing resources 24 for unauthorized use. FIG. 1 illustrates the computer system 22 as a rack server 26, which is commonly installed in server rooms and in server farms. The computer system 22, though, may be another processor-controlled device, as later paragraphs will explain. In this example, the computer system/server 22/26 is programmed to provide a permissive computing resource service 28 that reduces, or even prevents, unauthorized use of the computing resources 24. The computing resources 24 may include a hardware processor 30 (illustrated as “CPU”) that reads and executes an operating system 32 stored in at least one memory device 34. The computing resources 24 may also include one or more network interfaces 36, thus allowing bi-directional communications with other networked devices and services. The CPU 30, the memory device 34, and the network interfaces 36 are all installed within and/or mounted to a chassis (not shown for simplicity).

The computing resources 24, however, may also include an auxiliary data processing unit 38 (illustrated as “DPU”). The auxiliary DPU 38 is illustrated as a graphics processing unit 40 (or “GPU”), which is a common implementation of the DPU 38. The auxiliary DPU/GPU 38/40 interfaces with the CPU 30 and/or the memory device 34. The auxiliary DPU/GPU 38/40 allows the computer system/server 22/26 to execute additional workloads (such as graphics vectors, artificial intelligence, machine learning, and other high performance computing tasks). The auxiliary DPU 38, however, may also be implemented as a network interface card (or NIC), a peripheral card, or other hardware accelerator. Whatever the auxiliary DPU 38, the auxiliary DPU 38 may replace, supplement, and/or enhance data processing performed by the CPU 30. The CPU 30 and/or the operating system 32 may thus hand off or assign processing jobs/tasks/work 42 to the auxiliary DPU 38 for dramatically faster execution of additional workloads.

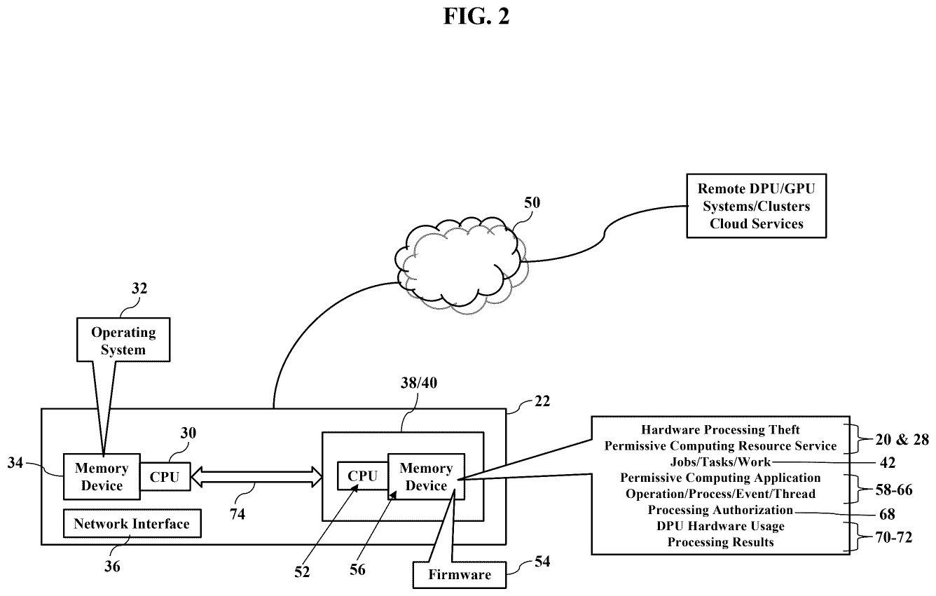

As FIG. 2 best illustrates, the CPU 30 and the auxiliary DPU 38 may cooperate to provide the permissive computing resource service 28. FIG. 2 again illustrates the auxiliary data processing unit 38 as the graphics processing unit 40 (or GPU). FIG. 2 also illustrates the auxiliary DPU/GPU 38/40 as locally installed within the chassis (not shown for simplicity) of the computer system 22. However, because the computer system 22 has the network interface(s) 36 to the Internet and to other communications networks 50, the CPU 30 may reach out and outsource the jobs/tasks/work 42 to remotely located auxiliary DPU/GPU systems/clusters and other cloud services (as later paragraphs will explain). Whatever the network/architectural arrangement, the auxiliary DPU/GPU 38/40 may have its own hardware processor 52 (illustrated as “CPU”) that executes an operating system 54 (illustrated as “firmware”) stored in at least one internal and/or external memory device 56. The CPU 30 may thus be referred to as a main or primary hardware processor, while the CPU 52 may be referred to as an auxiliary hardware processor or accelerator.

The auxiliary DPU/GPU 38/40 may be monitored. The auxiliary DPU/GPU 38/40 may also store and execute a permissive computing application 58. The permissive computing application 58 monitors the jobs/tasks/work 42 assigned to the auxiliary DPU/GPU 38/40. Examples of the jobs/tasks/work 42 include hardware and/or software operations 60, processes 62, events 64, and/or threads 66 requested/processed/conducted/executed by the auxiliary DPU/GPU 38/40. The permissive computing application 58, for example, checks whether the auxiliary DPU/GPU 38/40 is permitted to process the operations 60, processes 62, events 64, and/or threads 66. If a DPU/GPU processing authorization 68 is determined, then the permissive computing application 58 allows or authorizes a DPU/GPU hardware usage 70 of the auxiliary DPU/GPU 38/40. The auxiliary DPU/GPU 38/40 may thus process the operations 60, processes 62, events 64, and/or threads 66. The auxiliary DPU/GPU 38/40 may then send auxiliary DPU/GPU processing results 72 via a CPU-DPU interface 74 to the CPU 30. If, however, the DPU/GPU processing authorization 68 is not received, or is denied, then the permissive computing application 58 may deny the DPU hardware usage 70. The auxiliary DPU/GPU 38/40 may thus not process or may halt/suspend/terminate the operations 60, processes 62, events 64, and/or threads 66. The permissive computing application 58 thus monitors the computing resources 24 to detect unauthorized use of the auxiliary DPU/GPU 38/40.

The permissive computing resource service 28 thus detects and prevents the hardware processing theft 20. As we know, nearly every day we read of another network hack, computer virus, or other cybersecurity threat. Because the computer system/server 22/26 may be exposed to the public Internet, cyberattackers are expected to target the auxiliary DPU/GPU 38/40. Indeed, as machine learning and artificial intelligence grow in usage, cyberthreats may target ML/AI models processed by the auxiliary DPU/GPU 38/40. Infected ML/AI models may cause the auxiliary DPU/GPU 38/40 to act or perform in unknown or even harmful ways. The permissive computing resource service 28, however, protects the computer system/server 22/26 from new and unexpected cybersecurity threats affecting/infecting the auxiliary DPU/GPU 38/40.

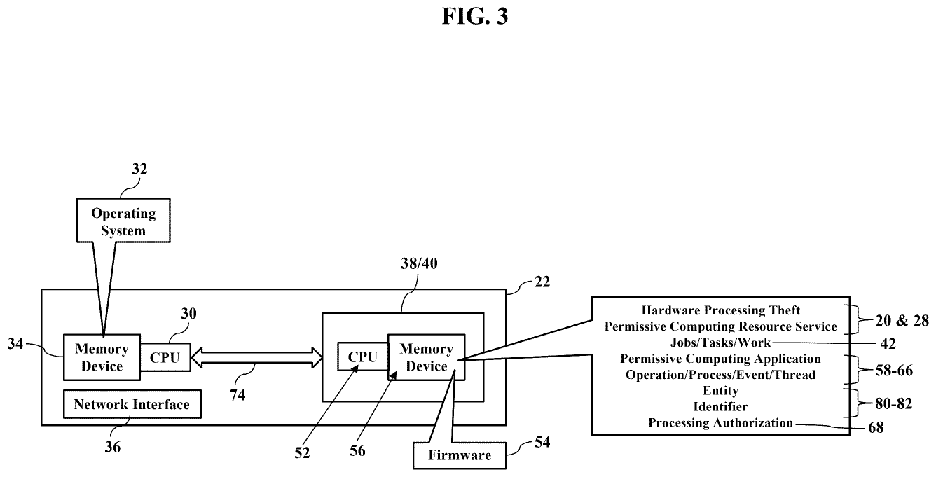

As FIG. 3 illustrates, the permissive computing resource service 28 may also expose processing details. As the CPU 30, the operating system/firmware 32/54, and/or the auxiliary DPU/GPU 38/40 interface and cooperate, the permissive computing resource service 28 may identify the jobs/tasks/work 42 assigned to the auxiliary DPU/GPU 38/40. For example, when the auxiliary DPU/GPU 38/40 is requested or instructed to process the operations 60, processes 62, events 64, and/or threads 66, the permissive computing application 58 may particularly identify one or more software/hardware entities 80. As an example, the operations 60, processes 62, events 64, and/or threads 66 may be associated with one or more unique identifiers 82 (such as an operation ID, process ID, event ID, and/or thread ID). Indeed, the operations 60, processes 62, events 64, and/or threads 66 may be associated with a filename, a software application, and/or a vendor. The CPU 30, the operating system/firmware 32/54, and/or the auxiliary DPU 38 may report the entity/entities 80 and/or the identifier(s) 82 and await the DPU/GPU processing authorization 68. If the DPU/GPU processing authorization 68 is affirmed, then the permissive computing application 58 allows or authorizes the auxiliary DPU/GPU 38/40 to process the approved/authorized jobs/tasks/work 42 (e.g., the associated operations 60, processes 62, events 64, and/or threads 66). If, however, the DPU/GPU processing authorization 68 is not received or is declined, then the permissive computing application 58 may deny the auxiliary DPU/GPU 38/40 processing permission or authorization. Simply put, if an unapproved or even a rogue entity 80 attempts to take over the auxiliary DPU/GPU 38/40, the permissive computing resource service 28 prevents unauthorized use.

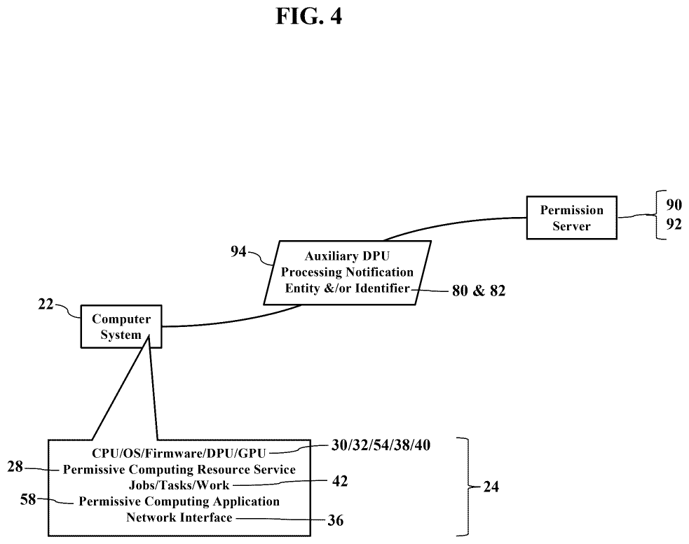

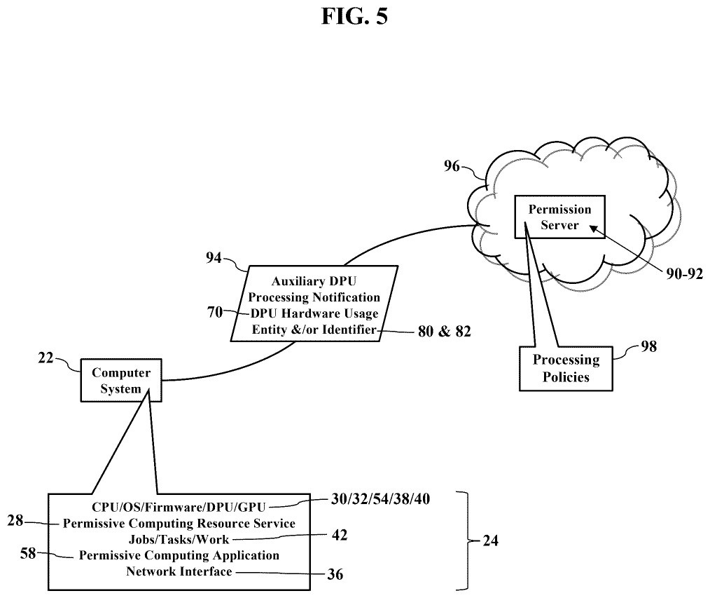

FIGS. 4-7 illustrate more examples of processing oversight. The CPU 30, the operating system/firmware 32/54, and/or the auxiliary DPU/GPU 38/40 cooperate to provide the computing resources 24. Whatever computing resources 24 are requested of the auxiliary DPU/GPU 38/40, the permissive computing application 58 may monitor the computing resources 24 assigned to the auxiliary DPU/GPU 38/40. FIG. 4, for example, illustrates the computer system 22 notifying a permission party 90 associated with the auxiliary DPU/GPU 38/40. As a simple example, the auxiliary DPU/GPU 38/40 may alert a manufacturer, fabricator, vendor/seller, or other representative associated with the auxiliary DPU/GPU 38/40. That is, before the auxiliary DPU/GPU 38/40 initiates minimal, partial, or substantial processing of the jobs/tasks/work 42 (such as the operations 60, processes 62, events 64, and/or threads 66 illustrated in FIGS. 1-2), the auxiliary DPU/GPU 38/40 may alert one or more permission servers 92 associated with the responsible DPU/GPU permission party 90. The permissive computing application 58, for example, may have programming or instructions that cause the CPU 30 and/or the auxiliary DPU/GPU 38/40 to perform operations, such as generating an auxiliary DPU processing notification 94. The auxiliary DPU processing notification 94 may have content, information, and/or data fields that specify the jobs/tasks/work 42 assigned to the auxiliary DPU/GPU 38/40. While other schemes may be used, the auxiliary DPU processing notification 94 may specify or include the operation/process/event/thread identifiers 82 (as explained with reference to FIGS. 1-2). The auxiliary DPU processing notification 94 may additionally or alternatively have content, information, and/or data fields that identify the entity 80 associated with the operation(s) 60, process(es) 62, event(s) 64, and/or thread(s) 66. The auxiliary DPU processing notification 94 may additionally or alternatively have content representing a current GPS location. The CPU 30 and/or the auxiliary DPU/GPU 38/40 may thus cooperate with the network interface 36 to send the auxiliary DPU processing notification 94 via the communications network 50 (illustrated in FIG. 2) to one or more notification network addresses associated with the permission party/server 90/92.

As FIG. 5 illustrates, the permission party/server 90/92 may then evaluate the computing resources 24 requested of the auxiliary DPU/GPU 38/40. Let's assume, for example, that the permissive computing application 58 is configured to alert NVIDIA®, a manufacturer of graphics processing units that may be used as the auxiliary DPU 38. The communications network 50 (illustrated in FIG. 2) routes the auxiliary DPU processing notification 94 to an IP address associated with an NVIDIA® cloud network/service 96 (such as an NVIDIA® gateway, router/switch, or server). The NVIDIA® permissions server 92 (and/or NVIDIA® personnel) may inspect the auxiliary DPU processing notification 94 and determine if the proposed DPU hardware usage 70 is acceptable. NVIDIA®, for example, may have one or numerous DPU processing policies 98 specifying permissible, and/or impermissible, uses of the auxiliary DPU/GPU 38/40. The NVIDIA® server/network/service 90/96 may thus compare the auxiliary DPU processing notification 94 to the parameters/specifications/rules associated with the DPU processing policies 98.

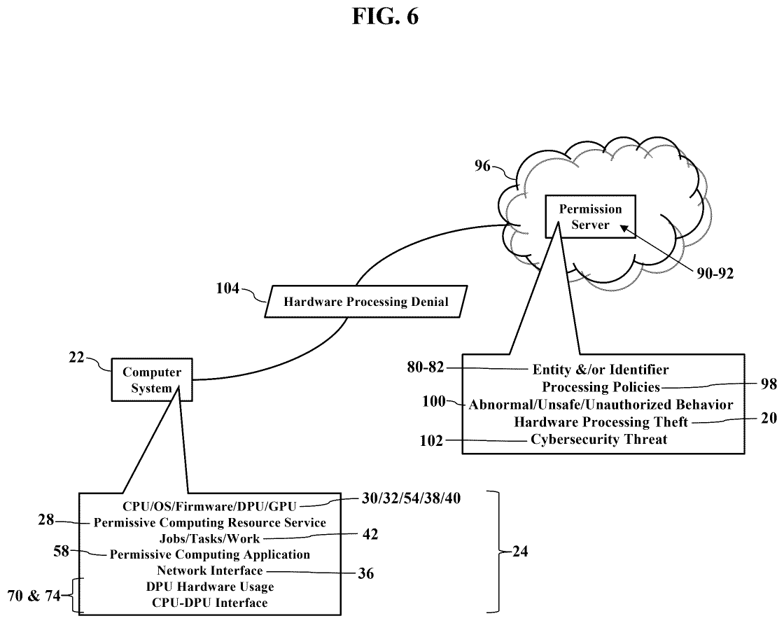

FIG. 6 illustrates DPU processing denial. When the auxiliary DPU processing notification 94 is received (as FIG. 5 illustrated), the NVIDIA® server/network/service 90/96, as examples, may compare the entity 80 and/or the operation/process/event/thread identifiers 82 to permissible/impermissible entities/identifiers 80/82 defined or specified by the DPU processing policies 98. If the auxiliary DPU processing notification 94 fails to match, conform to, equal, or otherwise satisfy the DPU processing policies 98, then the auxiliary DPU processing notification 94 may describe impermissible, unknown, and/or unspecified DPU activity. The jobs/tasks/work 42 assigned to the auxiliary DPU/GPU 38/40, in other words, violate the DPU processing policies 98. The jobs/tasks/work 42 may represent abnormal, unsafe, or even unauthorized auxiliary DPU behavior 100. The DPU hardware usage 70 may even be evidence of the DPU hardware processing theft 20 and/or a cybersecurity threat 102. Because the proposed DPU hardware usage 70 fails to conform to the DPU processing policies 98, the NVIDIA® server/network/service 90/96 may have computer programming or instructions that generate a hardware processing denial 104 as a cloud service response. The NVIDIA® server/network/service 90/96 may then send the hardware processing denial 104 to whatever destination/notification network/IP address is desired. In FIG. 6, for example, the hardware processing denial 104 is sent to a service client device (e.g., the computer system 22 hosting the auxiliary DPU/GPU 38/40 installed therein). When the computer system 22 receives the hardware processing denial 104 (such as via the network interface 36), the CPU 30, the operating system/firmware 32/54, and/or the auxiliary DPU/GPU 38/40 may cooperate to deny the DPU hardware usage 70. The CPU 30, as an example, may read and send/forward the hardware processing denial 104 via the CPU-DPU interface 74 (such as a PCIe interface) to the auxiliary DPU/GPU 38/40. When the auxiliary DPU/GPU 38/40 receives the hardware processing denial 104, the permissive computing application 58 may read the hardware processing denial 104 and determine that the proposed DPU hardware usage 70 is unauthorized. The permissive computing application 58 may thus cause or instruct the auxiliary DPU/GPU 38/40 to halt/terminate/suspend/abandon initial/remaining/queued hardware processing of the jobs/tasks/work 42 (such as the operations 60, processes 62, events 64, and/or threads 66 illustrated in FIGS. 1-2). Indeed, the permissive computing application 58 may merely instruct the auxiliary DPU/GPU 38/40 to slow down or delay hardware processing of the jobs/tasks/work 42. A ×1000 reduction in processing speed, for example, may be just as effective as termination. The permission party 90 has thus stopped unauthorized DPU hardware usage 70 and prevented the DPU hardware processing theft 20 and/or the cybersecurity threat 102.

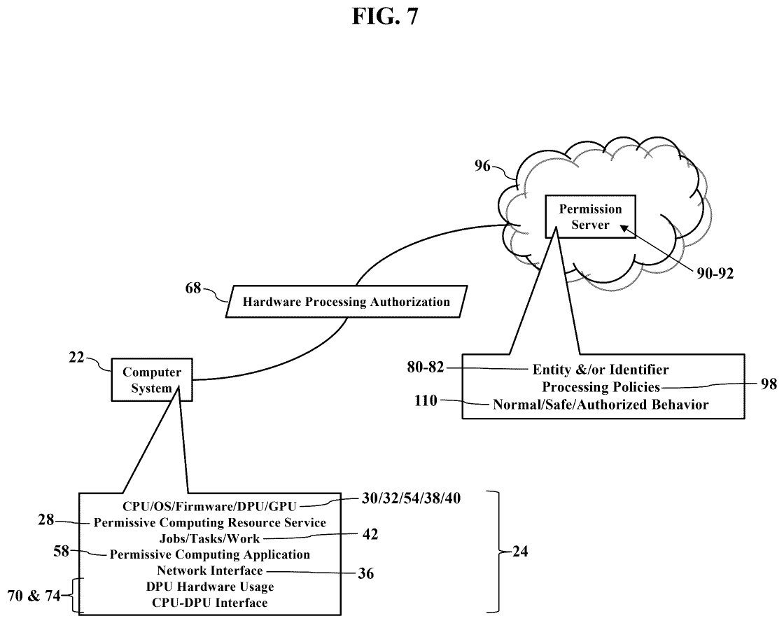

FIG. 7, however, illustrates DPU processing authorization. If the content described by the auxiliary DPU processing notification 94 (illustrated in FIG. 5) matches, conforms to, equals, or otherwise satisfies the DPU processing policies 98, then the auxiliary DPU processing notification 94 may describe permissible, known, and/or acceptable activity. The entity 80 and/or sequences of the operation/process/event/thread identifiers 82, for example, favorably compare or otherwise satisfy the DPU processing policies 98. The proposed DPU hardware usage 70, in other words, represents normal/safe/authorized auxiliary DPU behavior 110. Because the auxiliary DPU 38 is behaving, or will behave, as expected, the NVIDIA® server/network/service 90/96 may generate the DPU/GPU hardware processing authorization 68 as the cloud service response. The NVIDIA® server/network/service 90/96 may send the DPU/GPU hardware processing authorization 68 to whatever destination/notification network/IP address is desired (such as the client computer system 22 calling/invoking the auxiliary DPU/GPU 38/40). When the computer system 22 receives the DPU/GPU hardware processing authorization 68, the computer resources 24 cooperate to authorize/approve the DPU hardware usage 70. The CPU 30, for example, may read and send/forward the DPU/GPU hardware processing authorization 68 via the CPU-DPU interface 74 to the auxiliary DPU/GPU 38/40. When the auxiliary DPU/GPU 38/40 receives the DPU/GPU hardware processing authorization 68, the permissive computing application 58 may read the DPU/GPU hardware processing authorization 68 and cause the auxiliary DPU/GPU 38/40 to determine that the proposed DPU hardware usage 70 is authorized/approved. The permissive computing application 58 may thus cause or instruct the auxiliary DPU/GPU 38/40 to initiate, continue, and/or complete hardware processing of the jobs/tasks/work 42 (such as the operations 60, processes 62, events 64, and/or threads 66 illustrated in FIGS. 1-2). The permission party 90 has thus authorized the DPU hardware usage 70 as the normal/safe/authorized auxiliary DPU behavior 110.

As FIGS. 4-7 illustrate, the permissive computing resource service 28 improves computer functioning. Client devices (such as the computer system/server 22/26) abide with the permission party's processing policies 98. The permissive computing resource service 28 monitors the DPU hardware usage 70 assigned to the auxiliary DPU/GPU 38/40. When the auxiliary DPU/GPU 38/40 is requested to execute the normal auxiliary DPU behavior 110, then the jobs/tasks/work 42 are safe and pose no or little risk. When, however, the auxiliary DPU/GPU 38/40 is tasked with executing the abnormal or even unauthorized auxiliary DPU behavior 100, the DPU permission party 90 may stop the DPU hardware processing theft 20 and/or the cybersecurity threat 102. The permissive computing resource service 28 thus provides visibility of the activities assigned to, or requested of, the auxiliary DPU/GPU 38/40. Because the potential DPU hardware usage 70 is exposed, the permissive computing resource service 28 allows the DPU permission party 90 to a priori evaluate and approve/deny the DPU hardware usage 70. The permissive computing resource service 28 thus protects the auxiliary DPU/GPU 38/40 from malicious take overs and other cybersecurity threats 102. The permissive computing resource service 28 also protects the DPU permission party 90 from liability for abnormal/unauthorized auxiliary DPU behavior 100. Moreover, the permissive computing resource service 28 also protects the public in general from the effects and consequences of the abnormal/unauthorized auxiliary DPU behavior 100.

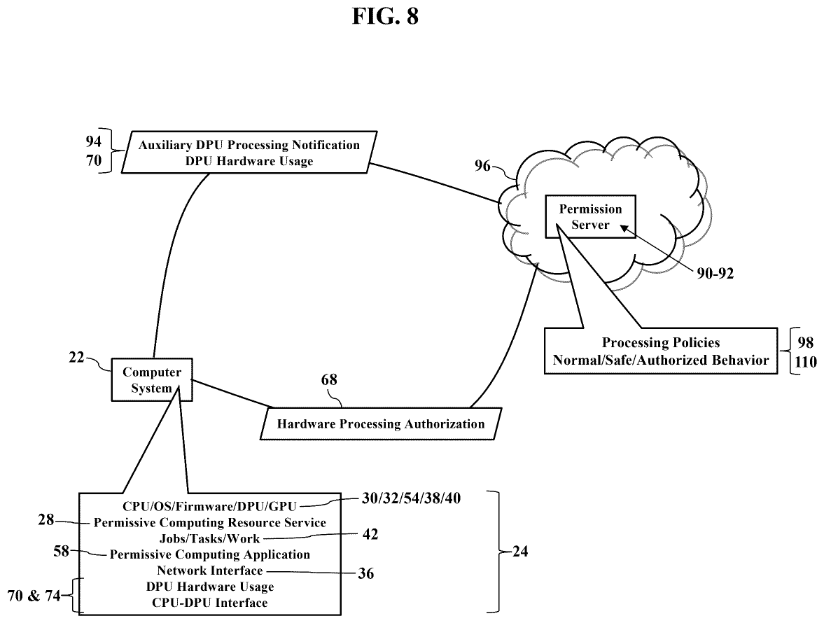

FIG. 8 illustrates examples of continued processing oversight. The permissive computing resource service 28 may be configured to repetitively or periodically obtain DPU processing permission. That is, even though the auxiliary DPU/GPU 38/40 may initially receive the DPU/GPU hardware processing authorization 68, the processing permission may only be temporary. The permissive computing resource service 28 may be configured to continuously, randomly, and/or periodically monitor and approve/deny additional DPU hardware usage 70. The permissive computing application 58, for example, may repeatedly instruct the auxiliary DPU/GPU 38/40 to generate the auxiliary DPU processing notification 94. Each successive auxiliary DPU processing notification 94, for example, describes the jobs/tasks/work 42 that are currently assigned to, or queued by, the auxiliary DPU/GPU 38/40. The computer system 22 sends each successive auxiliary DPU processing notification 94 to the permission party 90 (such as the permission party's server 92) for evaluation. The computer system's resources 24 may then monitor for the corresponding service response. If the corresponding DPU/GPU hardware processing authorization 68 is received, for example, then the corresponding DPU hardware usage 70 represents the normal auxiliary DPU behavior 110 and is authorized (as explained with reference to FIG. 7). The computer system 22 may randomly or periodically repeatedly request processing authorization from the permission party 90 until the jobs/tasks/work 42 are completed/executed and/or no jobs/tasks/work 42 are queued. Should, however, the hardware processing denial 104 be received, or no response is received, then the corresponding DPU hardware usage 70 is classified as the abnormal/unauthorized auxiliary DPU behavior 100 and the policy-offending jobs/tasks/work 42 are halted/terminated/suspended/abandoned (as explained with reference to FIG. 6). The computer system's resources 24 may thus be programed or configured to monitor for initial and subsequent DPU/GPU hardware processing authorizations 68 for continued processing of the jobs/tasks/work 42 assigned to the auxiliary DPU/GPU 38/40.

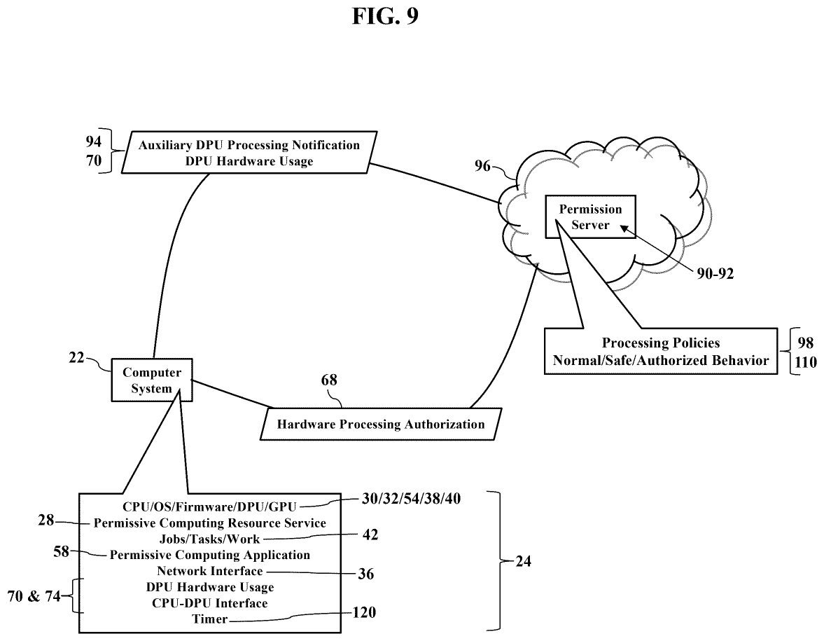

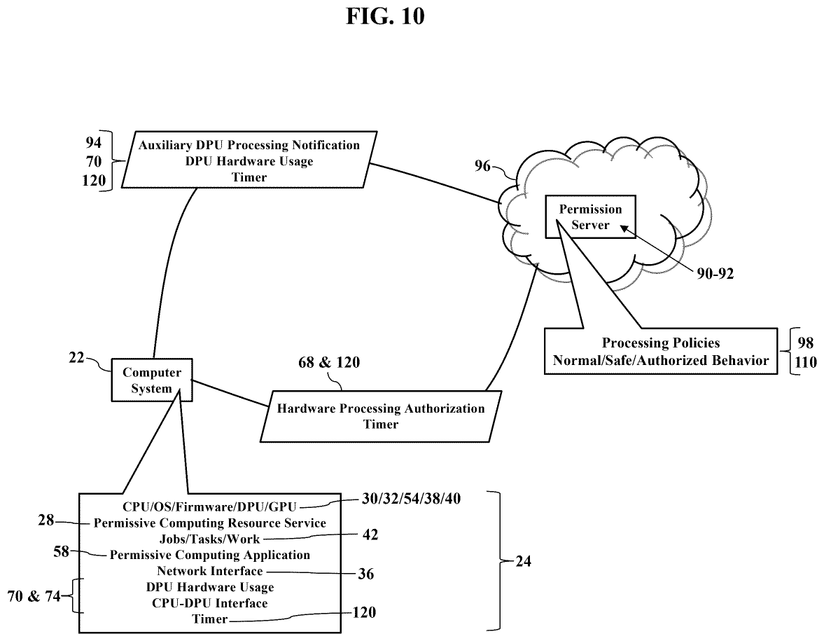

FIGS. 9-10 illustrate examples of timed DPU hardware usage 70. The CPU 30, the operating system/firmware 32/54, and/or the auxiliary DPU/GPU 38/40 may cooperate to provide the computing resources 24 requested of the auxiliary DPU/GPU 38/40. Whatever computing resources 24 are requested of, or assigned to, the auxiliary DPU/GPU 38/40, the permissive computing resource service 28 may first notify the permission party 90 by sending the auxiliary DPU processing notification 94. The auxiliary DPU processing notification 94 describes the jobs/tasks/work 42 requested of, or assigned to, the auxiliary DPU/GPU 38/40 (such as by specifying the entity 80 and/or the operation/process/event/thread identifiers 82, as explained with reference to FIGS. 4-7). If the computer system 22 receives the hardware processing denial 104, then the computer system 22 may deny the DPU hardware usage 70 (as explained with reference to FIGS. 4-7). Indeed, if the computer system 22 fails to receive a response to the auxiliary DPU processing notification 94 (such as a time out), the computer system 22 may be programmed to also deny the DPU hardware usage 70.

FIG. 9 illustrates a DPU/GPU processing timer 120. When the computer system 22 receives the DPU/GPU hardware processing authorization 68, then the computing resources 24 may cooperate to initiate the DPU/GPU processing timer 120. The DPU/GPU processing timer 120 commences at an initial value and increments/decrements from the initial value to a configurable final value. Moreover, as the DPU/GPU processing timer 120 increments/decrements from the initial value, the computing resources 24 commence the authorized/approved DPU hardware usage 70. The permissive computing resource service 28, for example, may cause or instruct the auxiliary DPU/GPU 38/40 to process the jobs/tasks/work 42 that correspond to the DPU/GPU hardware processing authorization 68. The computing resources 24 may continue processing the jobs/tasks/work 42, and/or reloading/queuing new jobs/tasks/work 42, as the DPU/GPU processing timer 120 counts up/down to its final value.

Timer expiration, though, may suspend DPU/GPU processing. The computing resources 24 may monitor the current value associated with the DPU/GPU processing timer 120 and compare the current value to the final value. When the current value equals the final value, the permissive computing application 58 may determine that the DPU/GPU processing timer 120 has expired. Because the DPU/GPU processing timer 120 has expired, the permissive computing application 58 may be configured to determine that DPU/GPU processing permission has also expired. The permissive computing application 58 may thus instruct the auxiliary DPU/GPU 38/40 to suspend/stop/halt hardware processing of queued or in-progress jobs/tasks/work 42 (such as the operations 60, processes 62, events 64, and/or threads 66 illustrated in FIGS. 1-2). Simply put, at expiration of the DPU/GPU processing timer 120, the permission expires and the current DPU hardware usage 70 may also expire.

FIG. 9 also illustrates DPU processing renewal. When the DPU/GPU processing timer 120 expires, additional DPU hardware usage 70 may be sought and approved. When the DPU/GPU processing timer 120 expires, the auxiliary DPU 38 may have some or many jobs/tasks/work 42 still in-progress and/or queued for execution. The permissive computing resource service 28 may thus request another DPU processing permission. The computing resources 24 (such as the CPU 30 and/or the auxiliary DPU/GPU 38/40) may cooperate, generate, and send another or subsequent auxiliary DPU processing notification 94 requesting additional DPU hardware usage 70 (as explained with reference to FIGS. 4-8). If the computer system 22 receives the corresponding, subsequent DPU/GPU hardware processing authorization 68, then the corresponding DPU hardware usage 70 may be renewed for another interval of time. The computing resources 24 may thus reset/initialize the DPU/GPU processing timer 120 and continue processing in-progress and/or queued jobs/tasks/work 42.

The permissive computing resource service 28 may thus cyclically request and approve the DPU hardware usage 70. Each auxiliary DPU processing notification 94 may request specific DPU hardware usage 70 (such as identifying the operations 60, processes 62, events 64, and/or threads 66 to be processed/executed, as explained with reference to FIGS. 1-2). The permissive computing resource service 28 may then monitor for the corresponding DPU/GPU hardware processing authorization 68 that authorizes the specified/identified DPU hardware usage 70. Each subsequent/successive DPU/GPU hardware processing authorization 68 may further authorize the timed DPU hardware usage 70 (perhaps according to the DPU/GPU processing timer 120). The permissive computing resource service 28 may periodically or randomly continue the timed DPU hardware usage 70 in response to renewed DPU/GPU hardware processing authorizations 68. The DPU hardware usage 70, however, may be complete when no more jobs/tasks/work 42 remain to be processed. The DPU hardware usage 70 may additionally or alternatively be complete when the specified/identified jobs/tasks/work 42 have been processed/executed prior to the expiration of the DPU/GPU processing timer 120. The DPU hardware usage 70, however, may terminate/stop/abandon in response to the hardware processing denial 104 (as explained with reference to FIG. 6). The DPU hardware usage 70 may also terminate/pause in response to a timed-out no reply to the auxiliary DPU processing notification 94.

FIG. 10 further illustrates the timed DPU hardware usage 70. When the computer system 22 generates and sends the auxiliary DPU processing notification 94, the auxiliary DPU processing notification 94 may request the timed DPU hardware usage 70. That is, the auxiliary DPU processing notification 94 may have content, information, or a data field that specifies the interval of time (e.g., the initial/final value(s) associated with the DPU/GPU processing timer 120). The subsequently corresponding DPU/GPU hardware processing authorization 68 may agree and authorize the requested interval of time. The permissive computing resource service 28, however, may have command, control, and/or override privileges. The DPU/GPU hardware processing authorization 68 may thus have content, information, or data field that specify approved initial/final value(s) associated with the DPU/GPU processing timer 120 (perhaps depending on the DPU processing policies 98, measures of risk, and other criteria). The computer systems resources 24 may be configured or programmed to abide by the DPU/GPU processing timer 120 specified by the permission party 90 and by its DPU/GPU hardware processing authorization 68.

The permissive computing resource service 28 further improves computer functioning. The auxiliary DPU 38 (such as the GPU 40) may only process the jobs/tasks/work 42 specified by the auxiliary DPU processing notification 94. Moreover, the auxiliary DPU/GPU 38/40 may only process the jobs/tasks/work 42 during the interval of time measured by the DPU/GPU processing timer 120. Even if the current DPU hardware usage 70 were to unexpectedly turn or transition from the normal/safe DPU behavior 110 to the abnormal DPU behavior 100, that abnormal DPU behavior 100 would be finite and terminate at the expiration of the DPU/GPU processing timer 120. Indeed, while the DPU/GPU processing timer 120 may have whatever length (e.g., seconds or minutes) is desired by the permissions party 90, the inventor envisions corporate/business/public policy limits on the timed DPU hardware usage 70. Even if the auxiliary DPU/GPU 38/40 were to somehow begin operating in rogue fashion, the DPU/GPU processing timer 120 confines the potential damage caused by rogue/infected/unknown artificial intelligence and/or machine learning. The DPU/GPU processing timer 120, for example, may have a 1-5 second value. Short intervals of expiration thus substantially limit the ability of malicious AI/ML models and other cybersecurity threats 102 to overtake the auxiliary DPU/GPU 38/40. Short intervals of expiration also severely restrict the ability of malicious AI/ML models to analyze large datasets (which often require hours of computations). Moreover, short 1-5 second intervals of expiration make permission granting a nearly continuous requirement, thus allowing the permissions party 90 to nearly instantaneously revoke permission/authorization. Indeed, the permissions party's server 92 may merely refuse to reply, thus in near real time halting the DPU hardware usage 70. The permissive computing resource service 28 may thus stop rogue/undesirable DPU hardware usage 70 in substantially real time (such as before a cybersecurity threat 102 propagates).

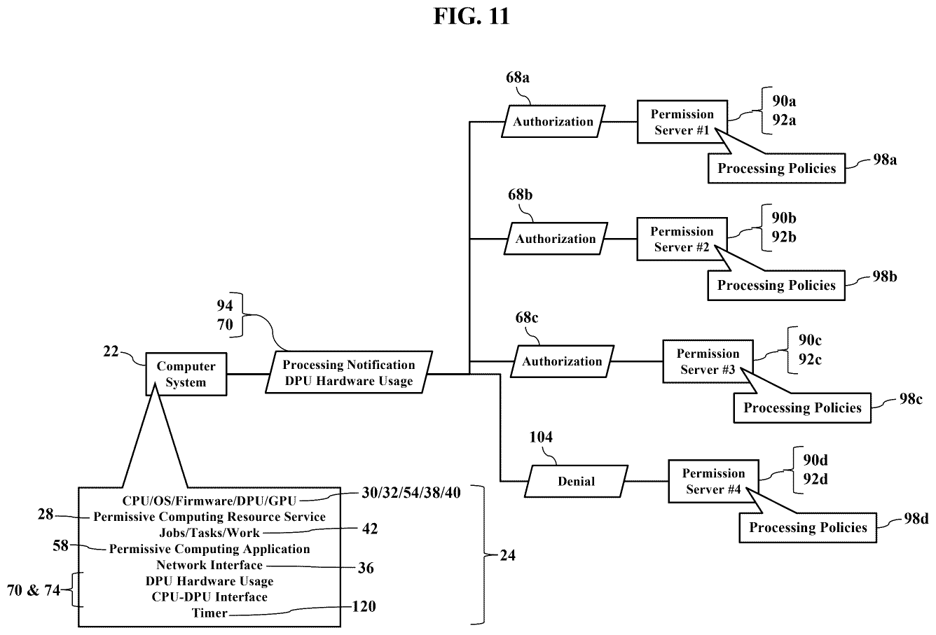

FIG. 11 illustrates examples of multiple permissions parties 90. This disclosure above explained processing oversight by the single permission party 90 (as explained with reference to FIGS. 4-10). The permissive computing resource service 28, however, may be configured to obtain DPU/GPU hardware processing permissions from multiple, different permissions parties 90. Indeed, the computer system 22 may request DPU/GPU processing permissions from tens or even hundreds of stakeholders (including local/state/national government). For simplify, though, FIG. 11 merely illustrates four (4) permissions parties 90a-d. Each permission party 90a-d may have its associated permissions server 92a-d that evaluates its associated DPU/GPU processing policies 98a-d. As even more simple examples, suppose that the computer system 22 is manufactured by DELL® and the CPU 30 is manufactured by INTEL®. Suppose also that the auxiliary DPU 38 is the graphics processing unit (or “GPU”) 40 manufactured by NVIDIA®. Furthermore, suppose also that the CPU 30 is executing a software application offered by ADOBE®. When the CPU 30 calls for the enhanced computing resources 24 provided by the auxiliary DPU/GPU 38/40, the permissive computing resource service 28 may be configured to notify all the involved DPU/GPU permission parties 90a-d. The CPU 30 and the auxiliary DPU/GPU 38/40, for example, may generate and send the auxiliary DPU processing notification 94 to the permission server 92a evaluating Dell's DPU/GPU processing policies 98a. The auxiliary DPU processing notification 94 may also be sent to the permission servers 92b-d evaluating Intel's, NVIDIA's, and Adobe's DPU/GPU processing policies 98b-d.

Each permissions party 90a-d may thus evaluate the proposed DPU hardware usage 70. When each permission server 92b-d receives the auxiliary DPU processing notification 94, each permission server 92b-d may have programming that compares the auxiliary DPU processing notification 94 to the corresponding DPU/GPU processing policies 98b-d (such as explained with reference to FIGS. 4-9). Each permissions party 90a-d, in other words, may have oversight privileges and may authorize or decline the proposed DPU hardware usage 70. Each permissions party 90a-d may thus individually/independently specify its own permissible, and/or impermissible, uses of the auxiliary DPU/GPU 38/40. The computer system's resources 24 (such as the CPU 30 and/or the auxiliary DPU/GPU 38/40) may thus be configured or programmed to await receipt of each permission party's DPU/GPU hardware processing authorization 68 (such as explained with reference to FIGS. 2-3 & 7). If each permission party 90 authorizes, then the computing resources 24 may cooperate to implement the proposed DPU hardware usage 70.

Some permission parties 90 may deny. In FIG. 11, for example, permission server 90d sends the hardware processing denial 104. The proposed DPU hardware usage 70, as described by the auxiliary DPU processing notification 94, may somehow violate the permission party's DPU/GPU processing policies 98d. Again, using the above example, suppose the CPU 30 is executing a software application offered by ADOBE®. If the permission server 90d is affiliated with ADOBE®, then the proposed DPU hardware usage 70, as described by the auxiliary DPU processing notification 94, offends Adobe's DPU/GPU processing policies 98d. Adobe's permission server 90d may thus send the hardware processing denial 104 to formally indicate (and log) its objection or refusal. (Adobe's permission server 90d, however, may simply fail to respond, thus informally implying its objection or refusal.) Because at least one of the permission parties 90 has formally or informally denied the proposed DPU hardware usage 70, then the computer resources 24 may be configured to terminate/abandon the proposed DPU hardware usage 70. While other permission strategies and/or combinations may be configured, in this example the permissive computing resource service 28 may be configured to obtain unanimous, or a majority, of DPU/GPU hardware processing permissions from multiple, different permissions parties 90.

However permissions are implemented, the processing permissions may be granular. For example, if actual DPU/GPU computation was disallowed, the end user may still be allowed to download memory content from the DPU/GPU. The permissive computing resource service 28, for example, may permit some DPU/GPU functions or capabilities, such as to checkpoint a particular computation run, so that it could be resumed from where it stopped once permission problems were resolved, even if hardware was powered down, repurposed or substituted in the intervening time.

The permissive computing resource service 28 may also provide update capabilities. Some of the permission parties 90, for example, may have privileges/credentials to replace/update the firmware 54 executed by the DPU/GPU 38/40. Ordinarily the manufacturer/fabricator of the DPU/GPU 38/40 may have update permissions. Other authorized/permissions parties, though, may update portions or modules associated with the firmware 54 (such as remotely or via a network, if digitally signed to be accepted by the DPU/GPU 38/40). Likewise, configurations may be uploaded and/or replaced as to which permissions servers 92 are required for operation (again, perhaps if digitally signed to be accepted by the DPU/GPU 38/40).

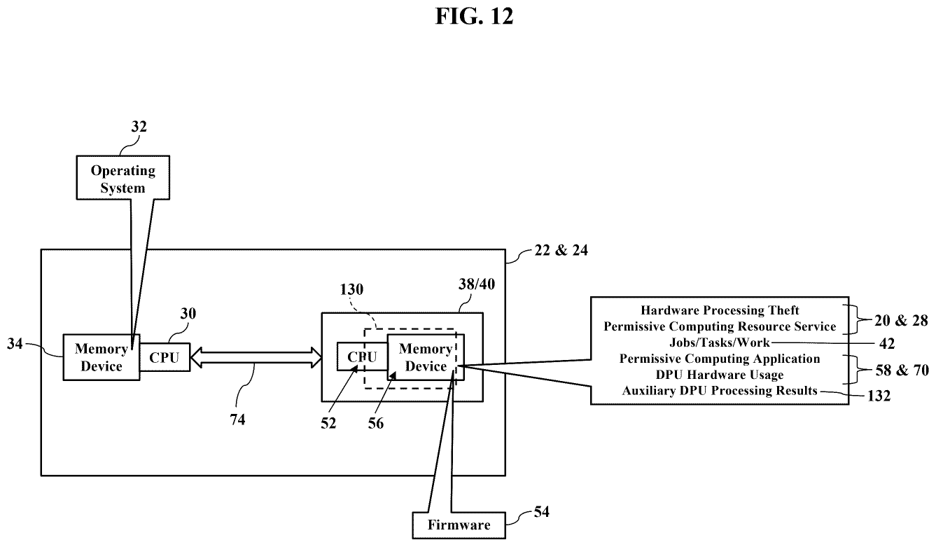

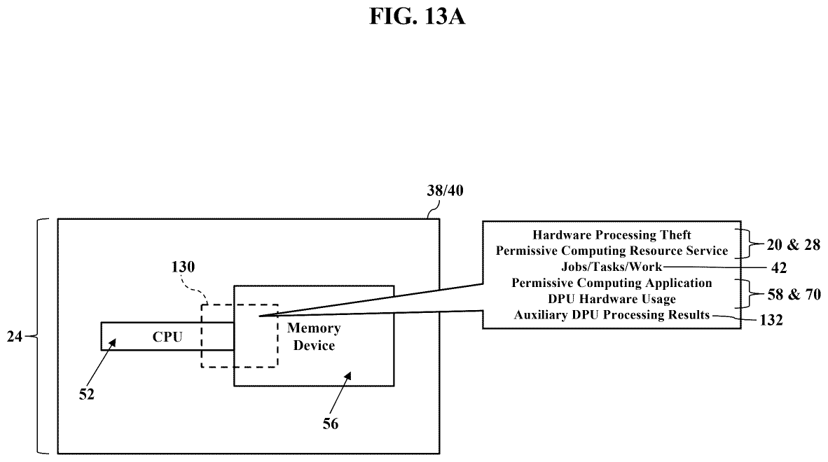

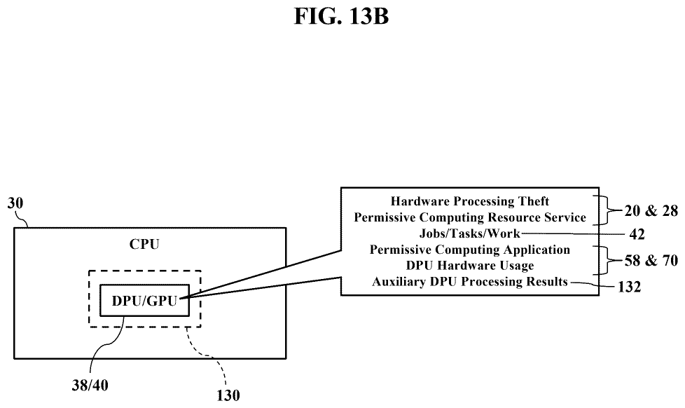

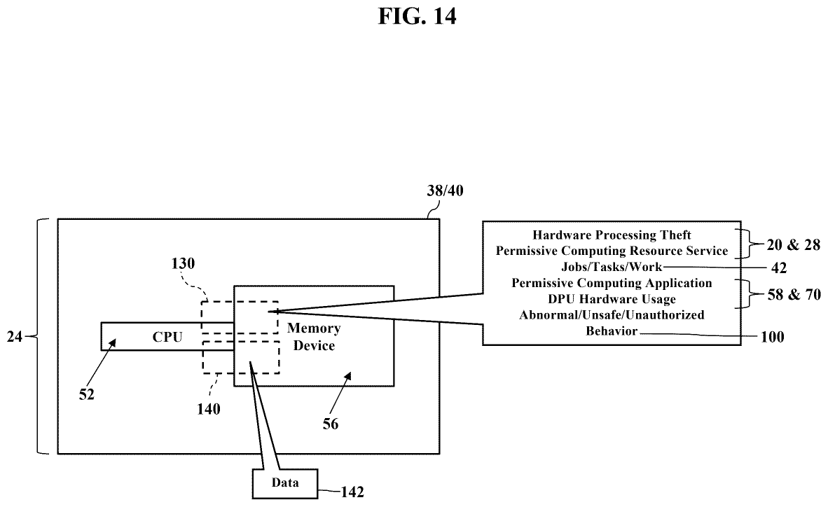

FIGS. 12-13A-B illustrate examples of endpoint processing protective trusted execution environments 130 (or TEEs). The endpoint host computer system 22 has the CPU 30 and the auxiliary DPU/GPU 38/40 installed therein. (Again, though, the auxiliary DPU/GPU 38/40 may be remotely located and accessed, as previously explained.) FIG. 12, for simplicity, illustrates the host computer system 22 as a single computing device, but the host computer system 22 may be implemented as a cluster of multiple computing devices. Indeed, the host computer system 22 may have multiple CPUs 30 and/or multiple auxiliary DPUs 38 (such as the GPUs 40) for high performance computing capabilities. Because the CPU 30 may be referred to as the primary or main processor, the CPU 30 couples to, and/or interfaces with, its primary/main memory device 34. The auxiliary DPU/GPU 38/40 may thus have its own dedicated/specialized CPU 52 (such as an ASIC) and its auxiliary memory device 56.

The CPU 30 and the auxiliary DPU/GPU 38/40 may cooperate to establish the processing protective trusted execution environment (or TEE) 130. The processing protective TEE 130 is a portion of the endpoint host's computing resources 24 that visualizes and detects the unauthorized hardware processing requested of, or assigned to, the auxiliary DPU/GPU 38/40. FIGS. 13A-B, as particular examples, illustrate the processing protective TEE 130 as a secure enclave entirely established within the auxiliary DPU/GPU 38/40. Some portion of the auxiliary DPU/GPU's computing resources 24 (e.g., the CPU 52 and memory device 56) may thus be established and/or designated as processing protective TEE 130 (e.g., dedicated CPU cores, memory partitions, and/or virtual machines). FIG. 13B, in particular, illustrates the DPU/GPU 38/40 as physically combined with the CPU 30. The main/primary CPU 30 and the auxiliary DPU/GPU 38/40, in other words, may be integrated as a single chip or module. The auxiliary DPU/GPU 38/40 may thus be a separate logical module fabricated within the main/primary CPU 30 (such as a laptop computer with an integrated GPU that is part of the CPU chip). The permissive computing resource service 28, however, may be implemented as an inseparable part of the DPU/GPU 38/40 (for example as an area on the same silicon die) to protect from disablement by removal or substitution. The same may be achieved using and separate modules, with digital signatures on their communication.

However the processing protective TEE 130 is implemented, the processing protective TEE 130 monitors and protects the auxiliary DPU/GPU 38/40. While the processing protective TEE 130 may have many uses, in these examples, the processing protective TEE 130 protects the auxiliary DPU/GPU 38/40 from partially or substantially executing unauthorized/abnormal/malicious jobs/tasks/work 42 (such as the operations 60, processes 62, events 64, and/or threads 66 to be processed/executed, as explained with reference to FIGS. 1-2). The processing protective TEE 130 isolates the DPU hardware usage 70 from other computing resources 24 (such as an application, container, or virtual machine) provided by the CPU 30. When the CPU 30, for example, assigns the jobs/tasks/work 42 to the auxiliary DPU/GPU 38/40, the permissive computing resource service 28 may have priority to first intercept, hold, and analyze the jobs/tasks/work 42. The processing protective TEE 130, for example, may access and execute the DPU/GPU permissive computing application 58 and identify proposed DPU hardware usage 70 (such as by determining the entity 80 and the identifiers 82, as explained with reference to FIG. 3). The processing protective TEE 130 may interface and/or cooperate with the CPU 30 to generate and to send the auxiliary DPU processing notification 94 to the responsible, permissive parties 90 (as explained with reference to FIGS. 4-8). If the permissive parties 90 majorly or unanimously authorize the DPU hardware usage 70 (as explained with reference to FIGS. 4-11), then the processing protective TEE 130 may release the jobs/tasks/work 42, thus allowing the auxiliary DPU/GPU 38/40 to process/execute the process the jobs/tasks/work 42 and to generate auxiliary DPU processing results 132. The auxiliary DPU processing results 132 may then be sent via the CPU-DPU interface 74 to the CPU 30.

Encryption may be used as additional processing protections. When the CPU 30, for example, sends the jobs/tasks/work 42 to the auxiliary DPU/GPU 38/40, the CPU 30 may use an encryption scheme/algorithm to encrypt the jobs/tasks/work 42. When the auxiliary DPU/GPU 38/40 receives the encrypted jobs/tasks/work 42, the decryption key(s) may only be accessible to, or known by, the processing protective TEE 130. In other words, only the processing protective TEE 130 may decrypt and read the jobs/tasks/work 42, so only the processing protective TEE 130 may identify the proposed DPU hardware usage 70 and send the auxiliary DPU processing notification 94. Because the auxiliary DPU/GPU 38/40 lacks access or knowledge of the decryption key(s), the auxiliary DPU/GPU 38/40 cannot decrypt/read/process the jobs/tasks/work 42. Moreover, the processing protective TEE 130 may additionally or alternatively encrypt the auxiliary DPU processing notification 94 using only cryptographic encryption/decryption keys available to the permissive computing resource service 28. Perhaps only the permission parties 90 may thus decrypt and evaluate the proposed DPU hardware usage 70.

Digital signing may be used as additional processing protections. Messages may be sent between the DPU/GPU 38/40, the CPU 30, the remote permission servers 92, and other modules, components, and network destinations. Those messages, as above explained, may or may not be encrypted. The messages, whether encrypted or not, may be digitally signed to verify authenticity. Recipients may then verify signatures before acting on the messages. Other authentication methods, such as digital certificate exchange, may also be used. Whatever digital signing scheme is used, digital signing prevents substituting the permissions servers 92 to bypass them.

The processing protective trusted execution environment 130 (or TEE) may be a DPU/GPU gatekeeper. Because the processing protective TEE 130 may be natively established within the auxiliary DPU/GPU 38/40, the processing protective TEE 130 may incorporate, and/or be responsible for the execution of, the DPU/GPU permissive computing application 58. The processing protective TEE 130 may thus generate the auxiliary DPU processing notification 94 and specify its dispersal to the permissions parties 90. The processing protective TEE 130 may monitor for and collect each permission party's DPU/GPU hardware processing authorization 68. The processing protective TEE 130 may monitor the DPU hardware usage 70 and may monitor the current value of the DPU/GPU processing timer 120. The processing protective TEE 130 may determine its expiration. The processing protective TEE 130 may then solicit renewals of the additional DPU hardware usage 70 by periodically/randomly updating and resending the auxiliary DPU processing notification 94 and monitoring for the subsequent hardware processing authorizations (as explained with reference to FIGS. 4-11).

FIG. 14 illustrates more examples of endpoint processing protective trusted execution environments (or TEEs). The auxiliary data processing unit (DPU) 38 (such as the graphics processing unit or GPU 40) may have multiple trusted execution environments. The auxiliary DPU/GPU 38/40, for example, may have established therein the processing protective TEE 130. The processing protective TEE 130 may thus be referred to as a first implementation of the multiple trusted execution environments. The auxiliary DPU/GPU 38/40, however, may have established therein a second data protective trusted execution environment (TEE) 140. The data protective TEE 140 is established to protect an electronic data 142 used/analyzed by the auxiliary DPU/GPU 38/40. The auxiliary DPU/GPU 38/40 may thus establish the data protective TEE 140 for confidential computing. Confidential computing protects an end user's data, and the person being protected is the customer with the data. The end user opts in to confidential computing (such as by not using servers that fail attestation). Confidential computing may rely on a secure processor or enclave (such as within the CPU 30 illustrated in FIG. 12). Moreover, with confidential computing, attestation is one-time; that is, once data is handed over, there is no point asking again as data is already released. Confidential computing is more fully described by U.S. Patent Application Publication 2024/0330436 to Atamli, et al. and incorporated herein by reference in its entirety, including parental U.S. Pat. No. 12,032,680 filed Mar. 31, 2022.

The processing protective TEE 130 differs from confidential computing. The permissive computing resource service 28 improves computer functioning by exposing the proposed DPU hardware usage 70 that is assigned for execution. The permissive computing resource service 28 requests processing permission prior to executing the proposed DPU hardware usage 70. The permissive computing resource service 28 thus reduces, and may even prevent, rogue work/jobs that represent the unsafe/abnormal DPU behavior 100. The permissive computing resource service 28 thus protects the permission parties 90, and even the general public, from the DPU hardware processing theft 20 that violates the processing policies 98 (as explained with reference to FIGS. 4-11).

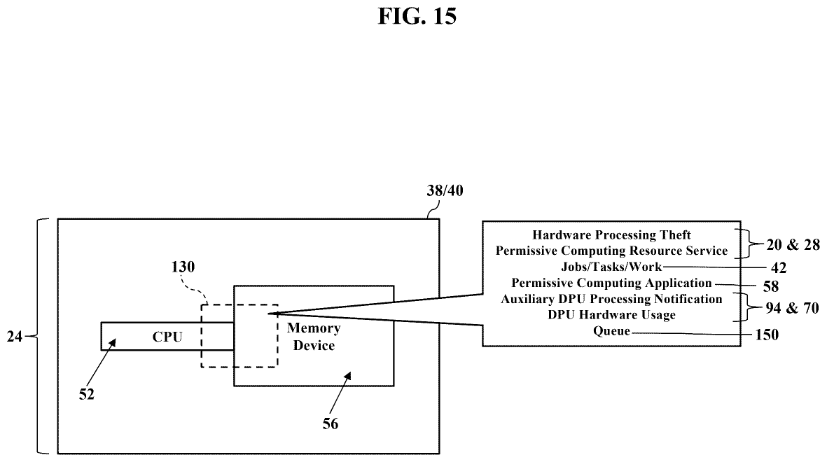

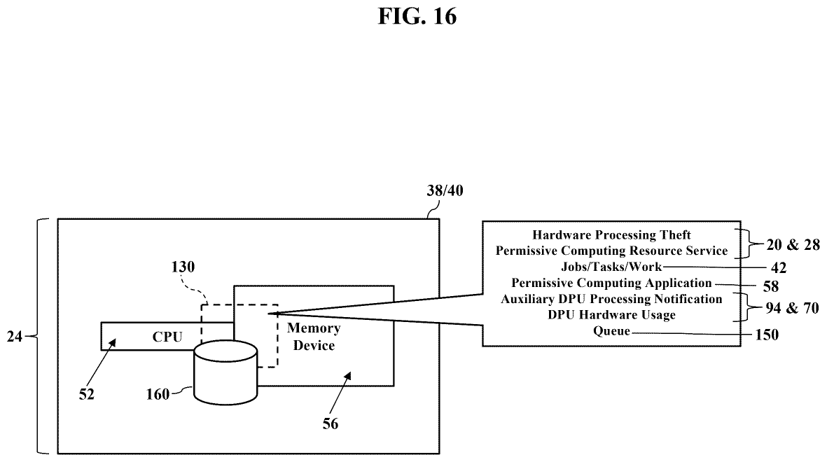

FIGS. 15-16 illustrate examples of queueing schemes. The processing protective TEE 130 protects the auxiliary DPU/GPU 38/40 from the DPU hardware processing theft 20. The processing protective TEE 130 thus detects the unauthorized DPU hardware usage 70. The processing protective TEE 130, for example, identifies the jobs/tasks/work 42 associated with a DPU/GPU queue 150. The DPU/GPU queue 150 queues the jobs/tasks/work 42 for execution by the auxiliary DPU/GPU 38/40. Before, however, the auxiliary DPU/GPU 38/40 is permitted to pull/retrieve the jobs/tasks/work 42 from the DPU/GPU queue 150, the processing protective TEE 130 may be programmed to hold/suspend the queued jobs/tasks/work 42 and first request processing permission. That is, the processing protective TEE 130 reads one or more of the queued (and perhaps en/decrypted) jobs/tasks/work 42. The processing protective TEE 130 generates the auxiliary DPU processing notification 94 (perhaps with cooperation from the CPU 30 illustrated in FIG. 12). The processing protective TEE 130 then sends the auxiliary DPU processing notification 94 to the responsible, permissive parties 90 (as explained with reference to FIGS. 4-11). If some or all of the permissive parties 90 responsively authorize the DPU hardware usage 70 (as explained with reference to FIGS. 4-11), then the processing protective TEE 130 releases the queued jobs/tasks/work 42 from the DPU/GPU queue 150. The auxiliary DPU/GPU 38/40 may thus execute the jobs/tasks/work 42 from the DPU/GPU queue 150. The auxiliary DPU/GPU 38/40 may thus not pull the jobs/tasks/work 42 from the DPU/GPU queue 150 before approval/authorization by the processing protective TEE 130.

FIG. 16 illustrates more queueing schemes. The processing protective TEE 130 may have authority to pick and choose the jobs/tasks/work 42 that load into the DPU/GPU queue 150. The processing protective TEE 130, for example, may have access to a DPU/GPU database 160 that stores the jobs/tasks/work 42 to be processed by the auxiliary DPU/GPU 38/40. The DPU/GPU database 160, for example, stores the jobs/tasks/work 42 sent by the CPU 30 (illustrated in FIG. 12) for execution by auxiliary DPU/GPU 38/40. For many reasons not pertinent here, though, the DPU/GPU database 160 may store the jobs/tasks/work 42 in no particular or sequential order. The processing protective TEE 130 may thus pick and choose the best/preferred/suitable jobs/tasks/work 42 that satisfy DPU/GPU performance measures (again, not pertinent). Because the processing protective TEE 130 may have sole authority to read the DPU/GPU database 160 and load the DPU/GPU queue 150, the processing protective TEE 130 may thus control the flow of the jobs/tasks/work 42 executed by the auxiliary DPU/GPU 38/40. The processing protective TEE 130, for example, may query the DPU/GPU database 160 for the jobs/tasks/work 42 satisfying some performance, timing, or other query parameter(s). The processing protective TEE 130 then generates and sends the auxiliary DPU processing notification 94 to the responsible, permissive parties 90 (as explained with reference to FIGS. 4-11). If some or all of the permissive parties 90 responsively authorize the DPU hardware usage 70 (as explained with reference to FIGS. 4-11), then the processing protective TEE 130 copies/inserts/loads the authorized jobs/tasks/work 42 into the DPU/GPU queue 150. The auxiliary DPU/GPU 38/40 may then pull the jobs/tasks/work 42 from the DPU/GPU queue 150 and execute. Because the auxiliary DPU/GPU 38/40 may have no read access the DPU/GPU database 160, and/or no authority/permission/ability to access/load the DPU/GPU queue 150, the auxiliary DPU/GPU 38/40 is prevented from executing the jobs/tasks/work 42 prior to approval/authorization by the processing protective TEE 130.

The auxiliary DPU/GPU 38/40 may further control DPU/GPU queue 150. The processing protective TEE 130 may monitor for responses to the auxiliary DPU processing notification 94 (as explained with reference to FIGS. 4-11). If one or more permissive parties 90 authorizes the proposed/queued DPU hardware usage 70, then the processing protective TEE 130 receives the DPU/GPU hardware processing authorization 68 (perhaps via the CPU-DPU interface 74). Should, however, one or more of the permissive parties 90 deny (or fail to respond) to the proposed/queued DPU hardware usage 70 (as explained with reference to FIGS. 4-11), then the auxiliary DPU/GPU 38/40 may lack authority. Because the proposed DPU hardware usage 70 was denied, the processing protective TEE 130 may execute programming that prevents the unauthorized DPU hardware usage 70. Because the proposed DPU hardware usage 70 was denied, the processing protective TEE 130, for example, may delete/clear the queued jobs/tasks/work 42 from the DPU/GPU queue 150. The processing protective TEE 130, as more examples, may delete the jobs/tasks/work 42 from the DPU/GPU database 160. Again, then, the processing protective TEE 130 protects the auxiliary DPU/GPU 38/40 from executing unauthorized jobs/tasks/work 42.

The permissive computing resource service 28 may be configured as desired. There may be times/situations/scenarios when the permission party 90, or an end user of the client device (such as the rack server 26), may have administrative privileges to opt out of the permissive computing resource service 28. In general, though, the permissive computing resource service 28 always operates for best policy reasons. Indeed, the permissive computing resource service 28 may effectively implement a continuous, near real time permissions granting scheme, in which the permission party 90 (e.g., the permissions servers explained with reference to FIGS. 4-11) must timely respond or refuse with silence (e.g., no reply).

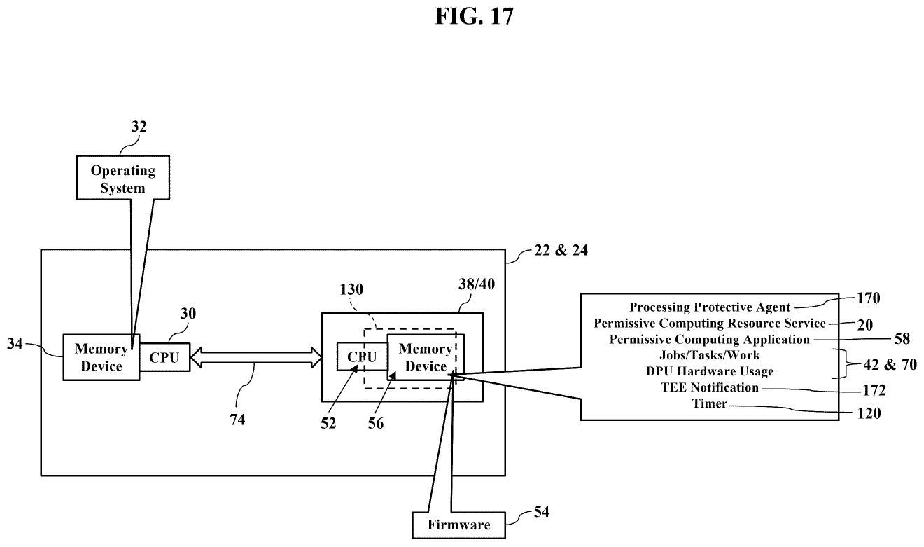

FIG. 17 illustrates examples of agent monitoring. An endpoint processing protective agent 170 may monitor the auxiliary DPU/GPU 38/40 and/or the processing protective TEE 130. The endpoint processing protective agent 170 may be loaded to and stored in the auxiliary memory device 56. The endpoint processing protective agent 170, however, may additionally or alternatively run elsewhere on the host in a different way, potentially using its own tamper resistant and/or tamper-evident protections and environment. FIG. 17, as examples, illustrates the processing protective TEE 130 having authority to execute the endpoint processing protective agent 170. The processing protective agent 170 may thus be another computing resource 24 that detects and stops the auxiliary DPU/GPU 38/40 from executing unauthorized jobs/tasks/work 42. The processing protective agent 170 includes computer programs, code, or instructions that scan and monitor its corresponding host (e.g., the auxiliary DPU/GPU 38/40 and/or the computer system 22 having the auxiliary DPU/GPU 38/40 installed therein). The processing protective agent 170, for example, may interface with the operating system 32 and/or with the firmware 54 to establish the processing protective trusted execution environment (or TEE) 130 as a secure enclave within the auxiliary DPU/GPU 38/40. The processing protective agent 170 may thus interface with the permissive processing application 58. Indeed, because the processing protective agent 170 may be a service provider providing at least a portion of the permissive computing resource service 28, the processing protective agent 170 may coordinate installation of the permissive processing application 58 as a service module. The processing protective agent 170 and the permissive processing application 58 may thus interface and coordinate oversight of the DPU hardware usage 70.

The processing protective agent 170 may monitor the DPU hardware usage 70 assigned to the auxiliary DPU/GPU 38/40. The permissive processing application 58, for example, may notify the processing protective agent 170 of communications conducted between the CPU 30 and the auxiliary DPU/GPU 38/40 (such as via the CPU-DPU interface 74). The permissive processing application 58 may notify the processing protective agent 170 of other activities, behaviors, data values, contexts, and/or patterns associated with either or both of the CPU 30 and the auxiliary DPU/GPU 38/40. The permissive processing application 58, for example, may generate a processing protective TEE notification 172 identifying the jobs/tasks/work 42 assigned to or associated with the auxiliary DPU/GPU 38/40. The TEE notification 172, as examples, may describe the entity 80 and/or the identifiers 82 associated with the jobs/tasks/work 42 retrieved from the DPU/GPU database 160 and/or the jobs/tasks/work 42 queued in the DPU/GPU queue 150 (as explained with reference to FIGS. 15-16). The permissive processing application 58 may then send the TEE notification 172 to the processing protective agent 170. The processing protective agent 170, as more examples, may have permissions to read/inspect the jobs/tasks/work 42 in the DPU/GPU database 160 and/or queued in the DPU/GPU queue 150. The processing protective agent 170, as a service provider providing at least a portion of the permissive computing resource service 28, may then request and obtain processing permission prior to loading the DPU/GPU queue 150 and/or prior to pulling from the DPU/GPU queue 150.

The processing protective agent 170 may request DPU/GPU authorization. However the processing protective agent 170 exposes the proposed DPU hardware usage 70, the processing protective agent 170 may first seek authorization from the permission parties 90. The permissive processing application 58 and the processing protective agent 170 may cooperate to select the jobs/tasks/work 42 from the DPU/GPU database 160 and/or to hold the jobs/tasks/work 42 in the DPU/GPU queue 150. The permissive processing application 58 and the processing protective agent 170 may also cooperate to generate and send the auxiliary DPU processing notification 94 (perhaps with cooperation from the CPU 30) to the responsible, permissive parties 90 (as explained with reference to FIGS. 4-11). If some or all of the permissive parties 90 responsively authorize the proposed DPU hardware usage 70 (as explained with reference to FIGS. 4-11), then the processing protective agent 170 may authorize the permissive processing application 58 and/or the processing protective TEE 130 to load the jobs/tasks/work 42 into the DPU/GPU queue 150 and/or to release the jobs/tasks/work 42 from the DPU/GPU queue 150.

The auxiliary DPU/GPU 38/40 may thus execute the authorized DPU hardware usage 70. One or more of the received DPU/GPU hardware processing authorizations 68, for example, may only authorize the timed DPU hardware usage 70 (such as by specifying the final value associated with the DPU/GPU processing timer 120, as explained with reference to FIGS. 9-11). If the DPU/GPU hardware processing authorizations 68 specify different or conflicting timed DPU hardware usage 70, then the processing protective agent 170 may resolve the conflict by selecting a smallest/shortest final value associated with the DPU/GPU processing timer 120. The processing protective agent 170, for example, may initialize the DPU/GPU processing timer 120 and instruct the permissive processing application 58 and/or the processing protective trusted execution environment (or TEE) 130 to transfer the jobs/tasks/work 42 in the DPU/GPU queue 150 to the auxiliary DPU/GPU 38/40 for execution. The processing protective agent 170 monitors the current value of the DPU/GPU processing timer 120 until its final expiration. The processing protective agent 170 may then instruct the permissive processing application 58, the processing protective TEE 130, and/or the auxiliary DPU/GPU 38/40 to halt execution at expiration.

The processing protective agent 170 may seek DPU processing renewal. When the DPU/GPU processing timer 120 expires, the processing protective agent 170 may request additional DPU hardware usage 70. When the DPU/GPU processing timer 120 expires, the auxiliary DPU/GPU 38/40 may have some or many jobs/tasks/work 42 in-progress and/or queued for execution. The processing protective agent 170 may thus request another DPU processing permission. The processing protective agent 170, for example, may generate another or subsequent auxiliary DPU processing notification 94 requesting additional DPU hardware usage 70 to complete the previously-queued and approved jobs/tasks/work 42. The subsequent auxiliary DPU processing notification 94, however, may additionally or alternatively identify new jobs/tasks/work 42 that were newly added to the DPU/GPU queue 150 during timer countdown. The processing protective agent 170 may thus cyclically request additional DPU hardware usage 70 and monitor for the corresponding DPU/GPU hardware processing authorization 68 that reauthorizes the timed usage (as explained with reference to FIGS. 4-11). The processing protective agent 170, however, may determine the hardware processing denial 104 in response to receipt of the hardware processing denial 104. The processing protective agent 170 may also terminate DPU/GPU execution in response to a timed-out no reply to the auxiliary DPU processing notification 94.

The processing protective TEE 130 may notify the processing protective agent 170. Because the processing protective agent 170 interfaces with its host's firmware 54, with the permissive computing application 58, and/or with the processing protective TEE 130, the processing protective agent 170 may be notified of any activities, messages, events associated with the auxiliary DPU/GPU 38/40. The processing protective agent 170 may thus have command and control over the firmware 54, the permissive computing application 58, and/or the processing protective TEE 130 to protect the auxiliary DPU/GPU 38/40 from executing unauthorized jobs/tasks/work 42.

The processing protective agent 170 may thus be a feedback mechanism. The processing protective agent 170 may be downloaded to client hosts operating in the field. Each client host installs the processing protective agent 170 to monitor the tasks assigned to auxiliary data processing units (or DPUs), graphics processing units (or GPUs), and other hardware accelerators. An array of the processing protective agents 170 may thus feed back group/cluster/population information about what each host is doing, in the wider sense, so a bigger DPU/GPU network picture can be formed. A cloud service provider (such as the permission party/parties explained with reference to FIGS. 3-11), for example, monitors what files are being loading, what programs are running, host ownership, host location, combined/installed GPU/memory/compute capacity, identifying file hashes, and whatever other parameters are desired. The cloud service provider pieces together this hostal/clusteral information for holistic views. So, even if it is in/unfeasible to identify what processing an individual DPU is performing, an aggregate view of computer machines is often revealing. One example would be determining whether someone is training a new GPT-5 on a 10,000-host cluster, or a smaller model on 10 hosts. These cases are very different when deciding to allow the use. Indeed, the permissions parties/servers 90/92 may information from other sources that aid in permissions decisions, such as billing systems, news providers, legal sources, social media, intellectual property records, and other content providers.

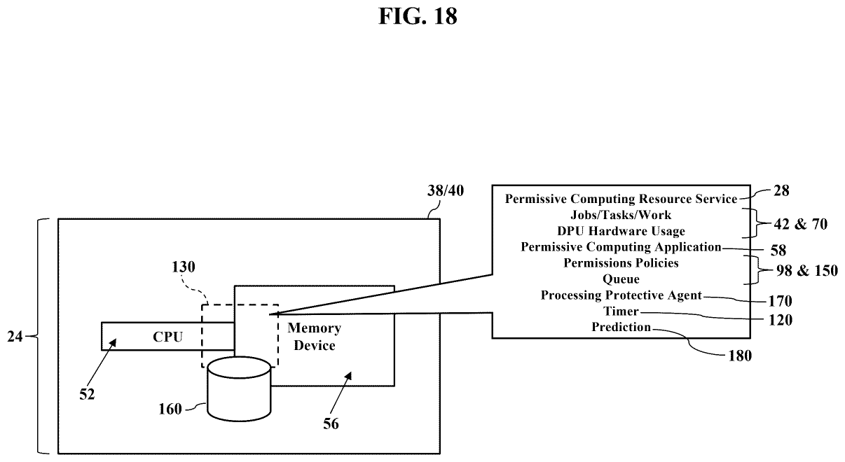

FIG. 18 illustrates examples of local assessment. The auxiliary DPU/GPU 38/40 may be loaded with programming to locally perform the permissive computing resource service 28 with little or no network/cloud access. The auxiliary DPU/GPU 38/40, for example, may store current, up-to-date versions of each permissions party's permission policies 98. When the jobs/tasks/work 42 are received, the auxiliary DPU/GPU 38/40 (i.e., the permissive computing application 58, the processing protective TEE 130, and/or the processing protective agent 170) may compare the jobs/tasks/work 42 to each permissions party's permission policies 98 (as explained with reference to FIGS. 4-11). The permissive computing application 58, the processing protective TEE 130, and/or the processing protective agent 170 may thus locally self-determine whether the proposed DPU hardware usage 70 is authorized or unauthorized. If the permission policies 98 are satisfied, then the permissive computing application 58, the processing protective TEE 130, and/or the processing protective agent 170 may load the jobs/tasks/work 42 into the DPU/GPU queue 150 and/or release the jobs/tasks/work 42 from the DPU/GPU queue 150. The permissive computing application 58, the processing protective TEE 130, and/or the processing protective agent 170 may thus generate a DPU/GPU processing prediction 180 based on the comparison of the jobs/tasks/work 42 to each permissions party's permission policies 98. If, for example, the jobs/tasks/work 42 partially or substantially match or lie within each permissions party's permission policies 98, then the permissive computing application 58, the processing protective TEE 130, and/or the processing protective agent 170 may predict that the proposed DPU hardware usage 70 is safe to execute (perhaps at least within the interval of time defined by the timer 120). If, however, the jobs/tasks/work 42 only minimally match or lie within each permissions party's permission policies 98, then the proposed DPU hardware usage 70 may be too risky to execute. Indeed, measures of similarity (e.g., a similarity analysis) may be used to compare the similarity of the jobs/tasks/work 42 to the permission policies 98. The resulting similarity values may then be compared to threshold values for authorization or unauthorization. The auxiliary DPU/GPU 38/40 may thus autonomously evaluate the jobs/tasks/work 42 with little or no network/cloud access.

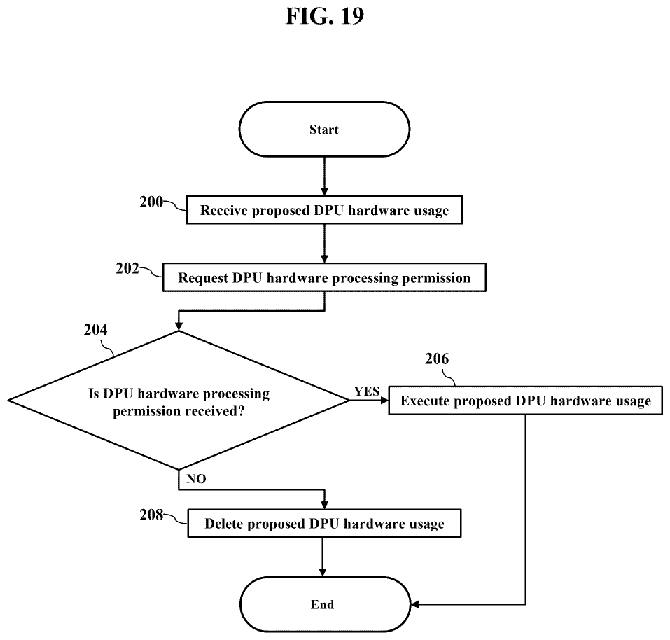

FIG. 19 illustrates examples of a method or operations that monitor the proposed DPU hardware usage 70. The proposed DPU hardware usage 70 is received (Block 200) and DPU/GPU hardware processing permission is requested from the permissions party 90 associated with the auxiliary DPU/GPU 38/40 (Block 202). If the hardware processing permission is received (Block 204), then the proposed DPU hardware usage 70 is executed (Block 206). If, however, the hardware processing permission is denied (Block 204), then proposed DPU hardware usage 70 is deleted (Block 208).

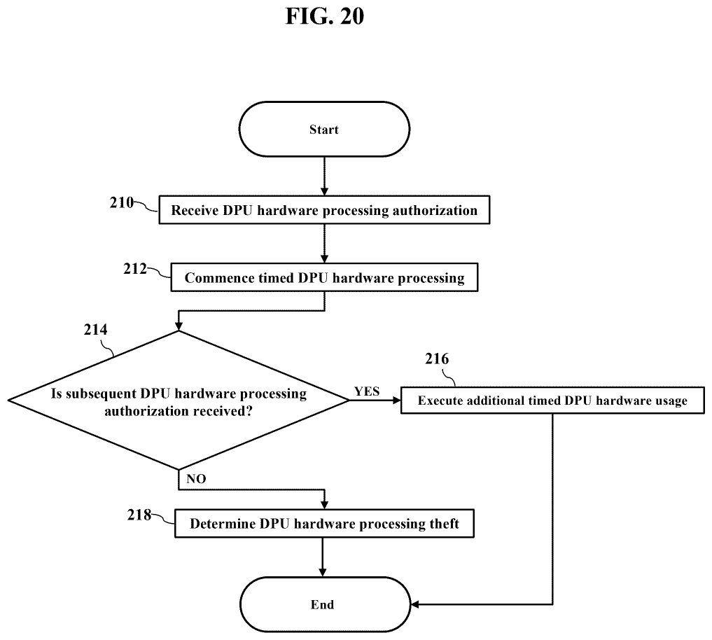

FIG. 20 illustrates examples of another method or operations that monitor the DPU hardware usage 70. The hardware processing authorization 98 sent by the CPU 30 is received (Block 210). The timed DPU hardware usage 70 commences (Block 212). If a subsequent hardware processing authorization 98 is received from the CPU 30 (Block 214), then the additional timed DPU hardware usage 70 is executed (Block 216). If, however, the subsequent hardware processing authorization 98 is not received (Block 214), then the additional timed DPU hardware usage 70 is determined to be the DPU hardware processing theft 20 (Block 218).

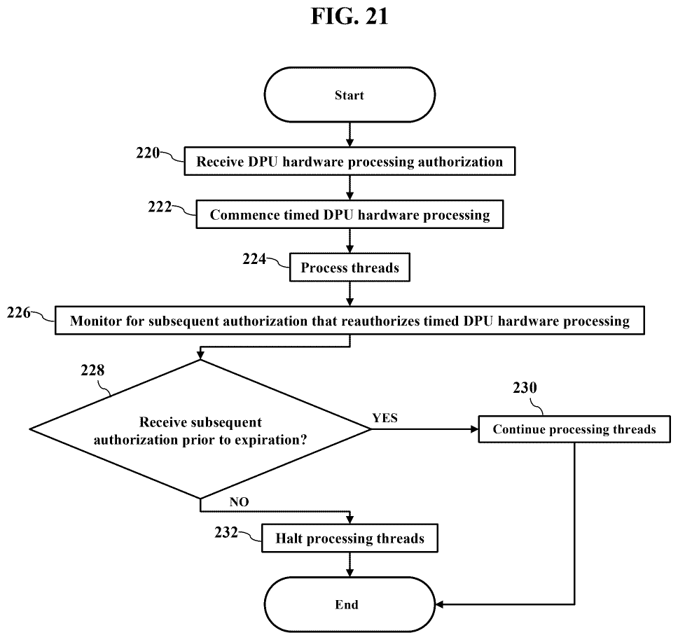

FIG. 21 illustrates examples of still more methods or operations that that monitor the DPU hardware usage 70. The processing protective agent 170 receives the hardware processing authorization 98 that authorizes the timed DPU hardware usage 70 (Block 220). The processing protective agent 170 commences the DPU hardware processing timer 120 (Block 222) and permits auxiliary DPU/GPU 38/40 to process one or more of the threads 66 (Block 224). The processing protective agent 170 monitors for the subsequent hardware processing authorization 98 that reauthorizes the timed DPU hardware usage 70 (Block 226). If the processing protective agent 170 receives the subsequent hardware processing authorization 98 prior to the expiration of the DPU hardware processing timer 120 (Block 228), then the processing protective agent 170 permits continued processing of the one or more threads 66 (Block 230). If, however, the DPU hardware processing timer 120 expires prior to receipt of the subsequent hardware processing authorization 98 (Block 228), then the processing protective agent 170 halts the processing of the one or more threads 66 (Block 232).

The memory devices 34 and 56 may have many embodiments. Examples of the memory devices 34 and 56 may include Dual In-Line Memory Modules (DIMMs), Dynamic Random Access Memory (DRAM) DIMMs, Static Random Access Memory (SRAM) DIMMs, non-volatile DIMMs (NV-DIMMs), storage class memory devices, Read-Only Memory (ROM) devices, compact disks, solid-state, and other read/write memory technology.

The computer system 22 may have many embodiments. This disclosure mostly discusses the computer system 22 as the rack server 24 (illustrated in FIG. 1). The computer system 22, though, may other stationary or mobile computing examples, such as a desktop computer, a tablet computer, a smartwatch, and a network switch/router. The computer system 22 may also be easily adapted to other embodiments of smart devices, such as a television, an audio device, a remote control, and a recorder. The computer system 22 may also be easily adapted to still more smart appliances, such as washers, dryers, and refrigerators. Indeed, as cars, trucks, and other vehicles grow in electronic usage and in processing power, the computer system 22 may be easily incorporated into a vehicular controller.

The above examples of the permissive computing resource service 28 may be applied regardless of the networking environment. The permissive computing resource service 28 may be easily adapted to stationary or mobile devices having wide-area networking (e.g., 4G/LTE/5G/6G/7G cellular), wireless local area networking (WI-FI®), near field, and/or BLUETOOTH® capability. The permissive computing resource service 28 may be applied to stationary or mobile devices utilizing any portion of the electromagnetic spectrum and a signaling standard (such as the IEEE 802 family of standards, GSM/CDMA/TDMA or other cellular standard, and/or the ISM band). The permissive computing resource service 28, however, may be applied to a processor-controlled device operating in the radio-frequency domain and/or the Internet Protocol (IP) domain. The permissive computing resource service 28 may be applied to a processor-controlled device utilizing a distributed computing network, such as the Internet (sometimes alternatively known as the “World Wide Web”), an intranet, a local-area network (LAN), and/or a wide-area network (WAN). The permissive computing resource service 28 may be applied to a processor-controlled device utilizing power line technologies, in which signals are communicated via electrical wiring. Indeed, the many examples may be applied regardless of physical componentry, physical configuration, or communications standard(s).

The permissive computing resource service 28 may utilize a processing component, configuration, or system. For example, the permissive computing resource service 28 may be easily adapted to a desktop, mobile, or server central processing unit or chipset offered by INTEL®, ADVANCED MICRO DEVICES®, ARM®, APPLE®, TAIWAN SEMICONDUCTOR MANUFACTURING®, QUALCOMM®, or other manufacturer. The permissive computing resource service 28 may even use multiple central processing units or chipsets, which could include distributed processors or parallel processors in a single machine or multiple machines. The central processing unit or chipset can be used in supporting a virtual processing environment. The central processing unit or chipset could include a state machine or logic controller. When any of the central processing units or chipsets execute instructions to perform “operations,” this could include the central processing unit or chipset performing the operations directly and/or facilitating, directing, or cooperating with another device or component to perform the operations.

The permissive computing resource service 28 may be applied regardless of the operating system. The permissive computing resource service 28 may be applied or adapted to processor-controlled devices executing the MICROSOFT® operating system (such as a version of the WINDOWS® and WINDOWS SERVER® operating systems). The permissive computing resource service 28 may be applied or adapted to processor-controlled devices executing the APPLE® operating systems (such as a version of the MACOS®, IOS®, and OS® operating systems). The permissive computing resource service 28 may be applied or adapted to processor-controlled devices executing a version of the LINUX®, ANDROID®, CHROMEOS®, UNIX®, and other operating systems.

The permissive computing resource service 28 may use packetized communications. When the computer system 22 communicates via communications networks, information may be collected, sent, and retrieved. The information may be formatted or generated as packets of data according to a packet protocol (such as the Internet Protocol). The packets of data contain bits or bytes of data describing the contents, or payload, of a message. A header of each packet of data may be read or inspected and contain routing information identifying an origination address and/or a destination address.

The permissive computing resource service 28 may utilize a signaling standard. The computer system 22 may use wired networks that interconnect network members. However, the computer system 22 may utilize other communications devices using the Global System for Mobile (GSM) communications signaling standard, the Time Division Multiple Access (TDMA) signaling standard, the Code Division Multiple Access (CDMA) signaling standard, the “dual-mode” GSM-ANSI Interoperability Team (GAIT) signaling standard, or a variant of the GSM/CDMA/TDMA signaling standard. The permissive computing resource service 28 may also utilize other standards, such as the I.E.E.E. 802 family of standards, the Industrial, Scientific, and Medical band of the electromagnetic spectrum, BLUETOOTH®, low-power or near-field, and other standard or value.

The permissive computing resource service 28 may be physically embodied on or in a computer-readable storage medium. This computer-readable medium, for example, may include CD-ROM, DVD, tape, cassette, floppy disk, optical disk, USB flash memory drive, memory card, memory drive, and large-capacity disks. This computer-readable medium, or media, could be distributed to end-subscribers, licensees, and assignees. A computer program product comprises processor-executable instructions for monitoring the DPU hardware usage 70, as the above paragraphs explain.

The diagrams, schematics, illustrations, and the like represent conceptual views or processes illustrating examples of the permissive DPU hardware processing. The functions of the various elements shown in the figures may be provided through the use of dedicated hardware as well as hardware capable of executing instructions. The hardware, processes, methods, and/or operating systems described herein are for illustrative purposes and, thus, are not intended to be limited to a particular named manufacturer or service provider.

As used herein, the singular forms “a,” “an,” and “the” are intended to include the plural forms as well, unless expressly stated otherwise. It will be further understood that the terms “includes,” “comprises,” “including,” and/or “comprising,” when used in this Specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, and so on, may be used herein to describe various elements, these elements should not be limited by these terms. These terms are only used to distinguish one element from another. For example, a first computer or container could be termed a second computer or container and, similarly, a second device could be termed a first device without departing from the teachings of the disclosure.

1. A method that monitors a proposed DPU hardware usage associated with an auxiliary data processing unit (DPU), comprising:
receiving, by a central processing unit (CPU), the proposed DPU hardware usage sent via a CPU-to-DPU interface from the auxiliary DPU, the proposed DPU hardware usage specifying an entity and operating system (OS) event identifiers;
suspending, by the CPU, the proposed DPU hardware usage associated with the auxiliary DPU;
sending, by the CPU, an auxiliary DPU processing notification via an Internet to the entity specified by proposed DPU hardware usage sent from the auxiliary DPU, the auxiliary DPU processing notification specifying the OS event identifiers associated with the proposed DPU hardware usage;
in response to receiving a local hardware processing permission indicating the entity approves the OS event identifiers associated with the proposed DPU hardware usage, then releasing, by the CPU, the suspending of the proposed DPU hardware usage by sending the local hardware processing permission via the CPU-to-DPU interface to the auxiliary DPU; and
in response to receiving a local hardware processing denial indicating the entity specified by the proposed DPU hardware usage denies the OS event identifiers, then denying, by the CPU, the proposed DPU hardware usage by sending the local hardware processing denial via the CPU-to-DPU interface to the auxiliary DPU.

2. The method of claim 1, further comprising determining at least one of a DPU physical theft or a DPU hardware processing theft associated with the auxiliary DPU.

3. The method of claim 1, further comprising establishing a processing protective trusted execution environment (TEE) in the auxiliary DPU.

4. (Canceled)

5. The method of claim 1, further comprising:
initiating a timer that increments in response to the local hardware processing permission; and
halting thread processing by the auxiliary DPU in response to an expiration of the timer.

6. The method of claim 1, further comprising cyclically receiving a new proposed DPU hardware usage assigned to the auxiliary DPU and requesting the hardware processing permission associated with the auxiliary DPU.

7. The method of claim 1, further comprising:
establishing a data protective trusted execution environment (TEE) in the auxiliary DPU that protects a data used by the DPU; and
establishing a processing protective TEE in the auxiliary DPU that protects the DPU from a DPU hardware processing theft.

8-20. (Canceled)

21. At least one computer system that authorizes hardware processing, comprising:
at least one auxiliary data processing unit (DPU) interfacing with a central processing unit (CPU), the at least one auxiliary DPU interfacing with at least one memory device storing instructions that, when executed by the at least one auxiliary DPU, perform operations, the operations comprising:
receiving a proposed DPU hardware usage associated with the auxiliary DPU, the proposed DPU hardware usage specifying multiple entities and operating system (OS) event identifiers;
suspending the proposed DPU hardware usage associated with the auxiliary DPU;
sending, by the CPU, an auxiliary DPU processing notification via an Internet to the entities, the auxiliary DPU processing notification specifying the OS event identifiers associated with the proposed DPU hardware usage;
in response to receiving unanimous hardware processing permissions from the entities approving the OS event identifiers associated with the proposed DPU hardware usage, then releasing the suspending the proposed DPU hardware usage and executing the proposed DPU hardware usage associated with the auxiliary DPU; and
in response to receiving a denial indicating an entity of the entities denies the OS event identifiers associated with the proposed DPU hardware usage, then deleting the proposed DPU hardware usage.

22. The at least one computer system of claim 21, wherein the operations further comprise determining at least one of a DPU physical theft or a DPU hardware processing theft associated with the auxiliary DPU.

23. The at least one computer system of claim 21, wherein the operations further comprise establishing a processing protective trusted execution environment (TEE) in the auxiliary DPU.

24. The at least one computer system of claim 21, wherein the operations further comprise receiving a hardware processing authorization that permits the proposed DPU hardware usage.

25. The at least one computer system of claim 21, wherein the operations further comprise denying the proposed DPU hardware usage in response to a time out prior to receiving a hardware processing authorization.

26. The at least one computer system of claim 21, wherein the operations further comprise cyclically receiving a new proposed DPU hardware usage assigned to the auxiliary DPU and requesting the hardware processing permission associated with the auxiliary DPU.

27. The at least one computer system of claim 21, wherein the operations further comprise:
establishing a data protective trusted execution environment (TEE) in the auxiliary DPU that protects a data used by the DPU; and
establishing a processing protective TEE in the auxiliary DPU that protects the DPU from a DPU hardware processing theft.

28. A memory device storing instructions that, when executed by at least one auxiliary data processing unit (DPU), perform operations, comprising:
receiving a proposed DPU hardware usage associated with the auxiliary DPU, the proposed DPU hardware usage specifying multiple entities and operating system (OS) event identifiers;
suspending the proposed DPU hardware usage associated with the auxiliary DPU;
sending an auxiliary DPU processing notification via an Internet to the entities, the auxiliary DPU processing notification specifying the OS event identifiers associated with the proposed DPU hardware usage;
in response to receiving unanimous hardware processing permissions from the entities approving the OS event identifiers associated with the proposed DPU hardware usage, then releasing the suspending and executing the proposed DPU hardware usage associated with the auxiliary DPU; and
in response to receiving a denial indicating an entity of the entities denies the OS event identifiers associated with the proposed DPU hardware usage, then deleting the proposed DPU hardware usage.

29. The memory device of claim 28, wherein the operations further comprise determining at least one of a DPU physical theft or a DPU hardware processing theft associated with the auxiliary DPU.

30. The memory device of claim 28, wherein the operations further comprise establishing a processing protective trusted execution environment (TEE) in the auxiliary DPU.

31. The memory device of claim 28, wherein the operations further comprise receiving a hardware processing authorization that permits the proposed DPU hardware usage.

32. The memory device of claim 28, wherein the operations further comprise denying the proposed DPU hardware usage in response to a time out prior to receiving a hardware processing authorization.

33. The memory device of claim 28, wherein the operations further comprise cyclically receiving a new proposed DPU hardware usage assigned to the auxiliary DPU and requesting the hardware processing permission associated with the auxiliary DPU.
